(19) United States
(12) Patent Application Publication
(10) Pub. No.: US 2024/0375841 A1
(43) Pub. Date: Nov. 14, 2024

(54) Beverage Container

(71) Applicants: Jesus Perea-OcHoa, Montebello, CA (US); Gina Morales, Rancho Cucamonga, CA (US)

(72) Inventors: Jesus Perea-OcHoa, Montebello, CA (US); Gina Morales, Rancho Cucamonga, CA (US)

(21) Appl. No.: 18/661,674

(22) Filed: May 12, 2024

Related U.S. Application Data
(60) Provisional application No. 63/465,879, filed on May 12, 2023.

(51) Int. Cl. B65D 75/54; B65D 33/25; B65D 75/26; B65D 81/18; G09F 3/00; G09F 3/02

(52) U.S. Cl. CPC B65D 75/54; B65D 33/2508; B65D 75/26; B65D 81/18; G09F 3/0297; G09F 2003/0273

(57) ABSTRACT

A beverage container includes a portable flexible beverage bag and an identification marker. The portable flexible beverage bag includes a bag wall configured by an inner layer and an inner layer to have at least one display surface, an absorbent layer surrounded by the outer layer, a valve positioned in a predetermined location of the beverage bag enabling an orifice for the absorbent material, and a dispensing apparatus arranged in the bag wall. The identification marker is a tokenization conjunction with NFT or NIL technology formed on the at least one display surface of the bag wall of the beverage bag.

### CROSS REFERENCE OF RELATED APPLICATION

This application is a non-provisional application that claims the benefit of priority under 35 U.S.C. § 119 to a provisional application, application No. 63/465,879, filed May 12, 2023, which is incorporated herewith by reference in its entirety.

### BACKGROUND OF THE PRESENT INVENTION

### Field of Invention

The invention relates to beverage containers, and more particularly to a beverage container with NFT and NIL tokenization that is air-tight and can be prefilled prior to sale.

### Description of Related Arts

Conventional beverage containers are generally made of plastic, glass, paper, aluminum Styrofoam, or a combination thereof. The amount of plastic and aluminum material used in these containers also varies with each beverage manufacturer. Some states have produced programs to combat the increase of waste production. For example, in California most beverages containers have a CRV cost that is added to the price of the beverage container and onto the retail purchase of a beverage container. The cost can be refunded to the entity that collects the beverage container and returns the beverage containers to an authorized recycling center. Yet plastics, bottles, glass, paper containers and aluminum cans continue to pollute our beaches, rivers, and environment because consumers continue to utilize these materials as beverage containers.

Traditional beverage containers lack the innovation for creativity and lack a system and method for a reduction of material without innovation for temperature control of the beverage. For example, presently there are global concerns about beverage containers and the waste products they produce yearly, including the exponential cost they create on our global financial markets. Primarily plastics, glass, paper, and aluminum are the four fundamental materials that are used to form most beverage containers packaging in our daily beverage consumption. The biggest problem with traditional beverage containers is the amount of raw material the plastics, glass, paper, and aluminum containers utilize in a single beverage container. In other words, too much plastic, glass, paper or too much aluminum for one single beverage container. One of the two biggest problems is over utilization of these four materials, plastic, glass, paper, and aluminum. The other is the general public perception of these four materials in relation to beverage containers. The general public views beverage containers as disposable waste products. Furthermore, these four materials are not recycled back into our ecosystem efficiently, thereby contributing to early global pollution. Both factors directly and indirectly contribute the increasing cost of these four products. Cleaning up the environment, after all waste products and pollutants are mixed within the environment has an exponential cost. There are two approaches for best solving this problem. The first is to reduce the amount of material for a single serving or eliminate the material all together. The second is to increase recycling material, therefore limiting the amount of undesired material reaching the environment as waste. The later action is currently being attempted with limited results.

Plastics, glass, paper and aluminum are among the leading materials for use in the manufacture of single beverage containers. Culturally and economically, we are dependent on plastic, glass, paper, and aluminum. It is important to make changes at multiple levels in the goal of reducing plastic, glass, paper, and aluminum as waste products. The beverage industry along with consumers must change current practices of providing no value on beverage containers. The beverage industry must also provide meaningful beverage containers for the consumers to embrace new beverage containers ideas.

In other words, most beverages have carbonation, fermentation, or aroma and therefore are time flavor dependent. The consumer gets the best product when the beverage is poured onto the container at the time of purchase, because the current beverage containers in-used lack air seal tightness capacity and lack the storable design for storing after being pre-filed. Also, conventional containers are bulky and once they are filled, they require additional space to be stored, to be sold at a later time of purchase.

Additionally, for traditional open containers, pre-filled are exposed to the climate and elements like wind and dust. Pre-filling traditional open beverages containers reduce the quality of the beverage, it reduces the carbonation or fermentation of the beverage, and increases contamination. The beverage turns flat and changes the taste of the beverage. Additionally, most flavored beverages lose their aroma with pre-filing. Therefore, the current standard practice is to not pre-fill most beverages containers.

The mention limitations in the traditional open beverage containers creates a stressful experience for families and large groups. The vender's work environment becomes stressful and the experience of the consumer changes from a desire experience to anxiety, where the consumer wishes to leave the waiting line, or for the waiting in line to be smaller, or for the venders to move faster or for the vender to have more staff. Both the consumers and the vender become frustrated with the decline of service, thereby greatly reducing the consumer experience. Worst case scenario for both the consumer and the vender is when the consumer elects not to purchase a beverage drink due to the traditional beverage containers limitations mentioned.

For example, in the attempt to reduce the waiting lines in large events some establishments provide beverages with the manufacture own containers. This practice also reduces the event experience because most big beverage manufactures have a pre-designated small to medium 8-16 oz drinking size consumption capacity for their beverage container. Therefore, most soft drinks and alcoholic beverages have a reduced quantity of their favor beverage at a higher price and consumers are faced with going in and out of the event to make additional beverage purchases during the event. Furthermore, this practice guarantees the multiple beverage containers to become an additional cost due to the multiple types of material. The consumer has two choices smaller multiple waiting lines (without pouring) for smaller volume beverages or one long waiting line for a larger beverage volume that requires pouring into a larger container. Additionally, the sale of various beverages with the manufacturer's own beverage container creates multiple types of trash plastic, glass, paper, aluminum, plastic with aluminum, and any other combinations. This type of supply and demand creates additional cost to separate the multiple beverage containers, and this is an additional cost neither the consumer, the establishment, nor the beverage manufacturer are willing to inherit. In the end the price of the beverage is increased to the consumer, to offset the cost for disposing of the various beverage containers.

Additionally, traditional beverage open containers like cup plastic, aluminum, ceramic, paper with any other combination of material they are open to the environment, they are bulky, they are inconvenient, and they are exposed to the environment dust and insects and most of all exposed to other humans, thereby increases the risk of droplets landing in and around the open cup or straw, especially in group settings with where others humans are exhaling, breathing, speaking, cheering, singing, coughing, and sneezing. The invention teaches a system and method for reducing droplets or impurities, a more hygiene method.

Consider the biggest waste production for independent events, the entertainment industry like, special events, specifically the large facilities stadiums sports events and or concerts. Each event varies in size and therefore also in waste production. Consumers attending large events desire to be entertained with less interruption during the social event. Presently, most consumers must wait in the beverage line to acquire a beverage without having any choice in the beverage container or service, as it relates to the beverage selection. In other words, the beverage container may come in only plastic, or aluminum or in a paper plastic combination open or close beverage container. It is important to mention in all these settings the said beverage containers are considered waste, by the consumer and the beverage industry. The beverage container will become trash and will be discarded at some point during the event. Hundred percent of the time these beverage containers will become waste. Furthermore, they are bulky and considered dirty and if the consumer is not careful, they have the potential of spilling and staining the consumer's personal gourmets. In other words, these beverage containers become undesired and ultimately become trash. This process is a vicious cycle for each beverage refilling of, water, soda, juice, etc. Nothing has been done to reduce the amount of material for each traditional single beverage container open or closed.

### SUMMARY OF THE PRESENT INVENTION

The invention is advantageous in that it provides a multilayer flexible beverage container that is airtight, that can be pre-filled prior to sale.

Another advantageous of the invention is to provide a multilayer flexible beverage container which is collapsible before and after consumption of the beverage, thereby reducing bulky storage space and waste space.

Another advantageous of the invention is to provide a multilayer flexible beverage container which single serving uses a fraction of the material that is currently being used in traditional single beverage containers open or close.

Another advantageous of the invention is to provide a method and system for extending the temperature of the contents in the beverage container without any glass for a single serving beverage container, open or close.

Another advantage of the invention is to provide a beverage container which can greatly benefit all industries from this invention, for example, through the NFT and NIL industries any item, wherein the multilayer flexible beverage container will teach consumers of eliminating the current ideation that the beverage containers are waste products. Cultural behaviors are the most difficult obstacle to overcome. Changing the public mental opinion from traditional disposable undesired beverage containers to collectibles, souvenir, memento and or memorabilia is possible with the correct system and method. NFT (Non-Fungible Token) and NIL (Name, Image and Likeness) market are a trillion-dollar industry, wherein the purchases of digital products are performed 24 hours/day. It is important to mention that, presently, most NFT and NIL items products have inherited limitations they do not have an associated physical structure, special occasion, a functional purpose or an emotional circumstantial relationship to an experience in relation to the original purchase. Furthermore, the NIL market will also be a trillion-dollar industry, and it also has a limited consumer connection. For example, the NFT or crypto digital product of an NIL, representing an athletic may not be altered, change or edited without losing its value.

Another advantageous of the invention is to provide a beverage container which is able to teach (N.I.L) Name, Image and Likeness with or without revenue sharing with an educational establishment, stadium, institute, business, social media, radio, television, shows, posts, and podcast personal appearances or via telecommunications for the purpose of producing revenue. Student/athlete Licensing rights to promoted, host, signed, livestream, chat, interview, produce and created contents, including test product and operate camps, create NFT apparels or accessories.

Another advantageous of the invention is to provide a beverage container which is capable of teaching (N.I.L) Name, Images and Likeness in other specialties, arts, music, engineering, chess, robotics, sports, and etc. The goal is for branding not to be limited to the traditional sports industry. In other words, the purchase, gifting, transfer, or ownership of a product with a NFT platform does not limit this invention utilization of other NFT one-of-a-kind designs and functions within the invention.

Another advantageous of the invention is to provide a beverage container which only authorizes NFT and NIL operator for the function of this invention.

Another advantageous of the invention is to provide a method and system for any physical item in synergy with NFT and NIL working together to procure monetary value while providing a function, a personal connection or an emotionally circumstantial attachment, thereby incentivizes a desire behavior. Additionally, NIL products like signing autographs products, social media clips, other custom apparels including other digital products like NFT, and crypto products can be incorporating, edited, or attached to the NTF in this invention, therefore making this NFT, “The Primary NFT or the Primary NIL”.

Another advantageous of the invention is that, through the association of the NFT and NIL, with the physical item (souvenir), the beverage container provides physical design and digital design for that one of the kind beverage container commemorating that one of a kind event with the capacity to customize the pre-selected NFT/NIL blockchain digital work associated with the physical event or physical item. Where the original beverage container design is customizable by the owner for creativity, emotional value or financial value. It is also possible for the original design on the physical beverage container not to be customized. Additionally, the new owners may or may partially or completely delete past customizations done by past owners. Furthermore, current beverage containers are created for one hand usage, one hand grasping. This greatly reduces the ability for one person to carry more than two beverage containers, one for each hand. Therefore, carry-on cup containers require additional more paper or plastic waste production to be manufacture. Furthermore, the time it takes to pour each beverage and to secure each container into the carry-on cup container is valuable time away from friends and love once, affecting the most valuable times away from the entertainment, family and friends.

Another advantageous of the invention is to provide a beverage container with NFT and NIL items which will greatly benefits the service industry, for example, the beverage container with NFT and NIL items improves consumers time and greatly reduce the time that it takes for every drink to be poured on to a container on demand. Additionally, the consumers are enticed to purchase additional plastic, aluminum, or other types of items as souvenirs, like cups and mugs that are not used during the event (not practical), not used after the event and eventually also become trash. Furthermore, memorabilia increase more wasteful material with items, like frames and banners. Memorabilia is more costly and is more of an ownership bragging right. Somewhere, in the middle between souvenirs and memorabilia are mementos. Mementos can be costly but tend to have a sentimental value above the financial value. In other words, consumers generally have four different types of purchases to make at all times as follows:
1. Buy a drink a biological necessity.
2. Buy a souvenir and artistic design capturing the event.
3. Buy memorabilia to brag and to show ownership.
4. Buy a memento to connect with the physical object and emotional attachment.

Furthermore, it is important to illustrate that currently consumers purchase various products mentioned above, but none of the products are interrelated or intertwine within the same product. Again, most purchases are done independent of each other. This adds to the vicious cycle of wasting material and not recycling material.

Another advantageous of the invention is to provide NFT and NIL products which have an association with a physical item the souvenir. For example, the beverage container, wherein the beverage container (souvenir) item has a system and method to increase the financial value and also the emotional value, thereby increasing the over-all value of the original souvenir purchase. Whether or not the item (souvenir) has a functional purpose, like the beverage container. According to the invention, it teaches once the item along with the method and system is activated to produce a NFT memento that blockchain can be edited, alter, change according to the owner's desire. The smartphone application computer programs enable the owner to make selection for editing the registered souvenir, therefore the current owner may make the desire changes as often as he/she wants in the NFT memento. It is important to mention that the physical souvenir (item) may or may not be in the possession of the owner when the souvenir (item) was created into an NFT memento. Once the NFT memento is created others will have the capacity to view said NFT memento via the web, social media, augmented reality AR, virtual reality VR, mixed reality MR, or extended reality XR, etc. At this point it will be possible for others to buy the NFT memento with or without the physical souvenir. The invention teaches the physical souvenir (item) has an identification marking that is used to generate the NFT memento through the smartphone computer application, therefore the combination is the most time consuming and therefore should be more valuable at the time of sale. Additionally, an NFI memento cannot be altered or changed again by another individual without the identification markings on the physical item (souvenir) through the smartphone computer application. Furthermore, the physical item (souvenir) is required for authentication and conversion of a souvenir or a NFT memento into memorabilia. It is important to mention NIL give athletes and non-athletes (with other attributes) their financial rights for monetization through the use of NFT blockchain technology, therefore the invention teaches NFT and NIL mementos are interchangeable within their category and NFT and NIL memorabilia are interchangeable within their category.

Another advantageous of the invention is that the invention teaches exclusivity as the means to increasing the financial and emotional value of said souvenir (physical items) and the digital computerized work (blockchain) share a symbiotic system, wherein the physical merchandise and digital computerize work, intertwined in a convenient manner. The first exclusion is the purchase of the said souvenir (item). The second exclusion is the registration to the one owner or group of owners. The third exclusion is not being an instant winner through the smartphone application verification process. The fourth exclusion is the customization and conversion of the NFT memento. The fifth exclusion is the physical retention of the souvenir (item) in mint condition. The sixth exclusion is the prolongation of NFT memento ownership. The seventh exclusion is the randomized selection for memorabilia conversion of the souvenir or of the NFT memento. The eighth exclusion is the physical ownership of the item (souvenir), with or without a NFT memento. The ninth exclusion is the customization and conversion of the NFT memento into the memorabilia NFT. It is important to mention, all the mention exclusions are important because, along every step mention there are circumstantial personal and life events that can limited the growth of the emotional value or the financial worth of the item (souvenir, NFT memento, or memorabilia) generationally. The “play of the game NFT” is mainly a financial exclusion, not everyone will be able to afford the immediate cost and also not every individual will be able to pay the cost associated with an auction type of sales. The “Play of the game NFT” merchandise and digital work (blockchain) may or may not be provided immediately. The owner also has the option to customize exclusive, or alteration of said original design on the play of the game NFT. Additionally, the physical play of the game NFT requires possession for future owners to register and customize the new purchase as it relates to the “Play of the game NFT” with the identification marks, number, code, or digits on the physical item. Customization and alteration created by the owner of the NFT/NIL memento, memorabilia, or the “play of the game NFT” have exclusions that may or may not increase the worth of the NFT/NIL, “Play of the game” personally and financially. It is possible for the NFT memento, memorabilia or play of the game NFT not to be customized or altered without increasing or decreasing the emotional or financial value. The new owner will have the option to keep or delete the alterations, customizations. The new owners will also have the option to add to the existing customization or to the nonexistent customization. All the NFTs and NILs will have the history of all past activities.

Another advantageous of the invention is that the invention teaches any item with a particular usage with souveniring design shapes, coloring and function, wherein the item is a reminder of a person, place or event. Furthermore, that souvenir can become a digital memento with a deeper and a more specific emotion. They can become an NFT memento with a more precise meaning to the owner for a person, place or event. The physical souvenir uniqueness becomes richer with the blockchain technology, after the digital work personalizing the experience, the event, the place or the artist. Therefore, producing alterations and changes in the blockchain ledger for others to discover, envy, agree, disagree, desire or enjoy is an extension of our inner selves. Creativity is the human spirit for others to value independent of your own sense of worth.

Another advantageous of the invention is to provide a method and system for NFT and NIL blockchain creations produce by small, medium and large entrepreneurs. For example, any car owner, bicycle owner independently or collectively (bicycle club) can produce an NFT or NIL blockchain. It is important to mention that the invention discloses souvenirs, mementos, memorabilia,” “Play of the game NFT” and any collectible to have a blockchain digital work produce in relation to the physical merchandise. In other words, through any computer system the owner/user may view the graphical blockchain. Through the computer application the user may or may not need to input the identification marks to have an observation option within the computer application, to have limited options in function, to have partial options or function, or to have complete full operational options and functions. Therefore, consumers can follow any industry and brand that provides merchandise or services with digital work. Therefore, blockchain creation is also desire like the physical item, like the physical event, like the physical convention, etc. It is important to mention the blockchain creations may come from the artist, the team, the league, the establishment, the vendor, etc. Furthermore, independent sole owners of any physical item may now have the platforms for blockchain digital work development, for the sale and purchase of blockchain products, including the sale and purchases of said physical items. It is important to mention that the original NFT/NIL blockchain design is the primary NFT or the primary NIL, they are the source from where all alterations and customizations are produced. The Primary NFT or Primary NIL are the original blockchain design, product or digital work produced by the team, league or by the sole owner. In other words, the invention teaches other blockchain products may be used in conjunction with the primary NFT or NIL for creativity. Other non-affiliated digital work blockchain services products may or may not have authorization for using a Primary NFT or Primary NIL blockchain services or any other product, partially or completely, by a non-affiliated NFT or NIL digital community.

Another advantageous of the invention is to provide a method and system for random selection of souvenirs to become memorabilia (more exclusive) with additional financial value. In other words, one product with multiple product descriptions, ever-changing and with a monetary ranking system and a personal value system for synergistic growth. For example, the beverage container sold at a concert to a couple, is an item (beverage container) with function for disposing a beverage, that becomes a souvenir after providing the beverage consumption. In the future that couple gets married and now that souvenir is created by the husband into a NFT memento commemorating their first shared beverage during the concert they fall in love. Eventually the identification number of that NFT memento is randomly selected for memorabilia status chip and certify increasing the value of the original purchase. Additionally, consider that couple becomes famous, that NFT memento now has more valuable to other people and only becomes more exclusive after acquiring memorabilia status. Furthermore, the array of multiple owners in time can be traced by the NFT/NIL mementos, the NFT/NIL memorabilia, the “Play of the game” and any collage collection, as a true time capsule for generations to come. In other words, we become immortals, through the NFT or NL. The blockchain can have any identification marker, serial code or type of physical certification group consisting of unique product identifiers UPC, EAN, JAN, ISBN, Brand, MPN and may or may not be changed in the memorabilia process. A souvenir may have preselected serial codes or types of physical certification, numeric in any language, lettering in any language, digital, square code, bar code, laser, engraved, printed, water marked, luminescent, chemical reaction, 3D security ribbon, color-shifting ink, portrait watermark, microprinting, raised printing, EURion constellation, chip/tag, digital blockchain and any preselected color glow. The identification marks, lettering, symbols numbers may be physical visual or in any serial code or type of physical certification, including unique product identifiers UPC, EAN, JAN, ISBN, Brand, MPN. Additionally, the souvenir may have a computer application for any serial code or physical certification, where the user takes the picture, and the picture is up-loaded on the computer application as the process to certify the souvenir time and date of purchase. Additionally, the picture can be used to modify, alter, edit, or manipulate the original souvenir design (blockchain) with the picture on record when creating an NFT smart contract thereby creating an NFT Memento personalized. It is also possible the NFTs may only have one NFT community, thereby making it illegal for other NFT communities to have any portion of said invention. Alternatively, one or more selected NFT communities may operate together. Additionally, various NFT communities may operate a selected function, for example one NFT community may only operate Souvenirs. Another may only operate NFT mementos, and etc.

Another advantageous of the invention is to provide a development of the primary NFT or NIL blockchain including the changes and alterations of said items in a historical value capturing the moment, the circumstances the struggle, the history of each primary NFT, of each primary NIL. In other words, it is a time capsule capturing our humanity and the trajectory of our civilization, and not just the triggers “the events”, more important the periphery of “the events”. It is important to mention that the digital NFT memento or NIL mementos are more valuable with the physical souvenir because there is more money and time consumption in relation to keeping the maintenance on the physical item and the blockchain process in the creation of a digital NFT memento or NIL memento, with or without customization. Alternatively, they can be sold together or individually. For example, this invention embodies the beverage container as a souvenir. The invention is not limited to a beverage drinking container. It can be any physical product (souvenir) that incorporates digital work in any form or shape on the image of the original physical product. Furthermore, an NFT memento is produced when the owner, seller or buyer of the physical product pays to produce the NFT digital design on a (blockchain) with or without any changes to the original design NFT or NIL. In any method the original physical souvenir is created into a NFT memento, for others to look at acknowledge, like or dislike. It is important to mention the same identification mark numbers, letters, codes and symbols on the physical product will be placed on the digital NFT memento and NIL memento, therefore the one-of-a-kind uniqueness is more exclusive. Where the Identification marks cannot be edited change or alter on the digital NFT, nor on the physical souvenir (item). The identification marks are numbers, letters, codes and symbols on the physical product are permanent markers placed on physical souvenir for originality, including any group consisting of unique product identifiers, physical numeric mark, a square code, a barcode, a laser mark, a print, a watermark, a luminescent mark, a chemical reactive mark, a chip, a tag, conceal scratcher, UPC, EAN, JAN, ISBN, Brand, and any MPN,

In other words, the identification number lets the user know the history of the NFT, the history of the souvenir (physical product), with the identification number the seller and buyer will know the authenticity of the transaction. It is possible to sale the NFT or the souvenir with or without a NIL independent of each other. It is more limiting to have the same physical product corresponding to the same identification number on the NFT digital memento and therefore the combination of physical product and digital NFT memento corresponding to the same identification mark, numbers should be worth more. Furthermore, the identification mark is the random yearly process by which the souvenir, the NFT mementos and the NIL mementos are elevated to memorabilia status. It is important to know in this selection process the souvenir identification number is on the actual physical product and will be used to identify the product as a memorabilia classification. The memorabilia classification is worth more than the NFT memento, NIL memento or the souvenir status. This provides a ranking system by limitations (supply and demand). In other words, theoretically there are more quantities of a particular item, souvenir, or one-of-a-kind product. Therefore, they are less NFT mementos because not every original souvenirs purchased are created into a NFT memento by the current owner or INL mementos because not all souvenirs have a signature of the players, team etc., and not all owners create a blockchain digital signature design. Likewise, there is less memorabilia than NFT memento or NIL memento. Souvenirs are any items picked, purchased or gifted. That in the future are selected through a random process for blockchain acquisition and therefor the physical product is elevating from the souvenir status to the NFT or NIL memorabilia, with or without digital customization. It is important to mention, NFT and NIL mementos have previous blockchain digital work that was purchase by the current owner or previous owners, therefore, after the random selection process the new selected NFT or NIL memorabilia previous blockchain may or may not return to the original NFT or NIL blockchain design that was created for that particular souvenir or event. In other words, if there is new owner of a NFT memento or NIL memento at the time of the random selection process then that new owner doesn't get penalized by the previous owner digital alterations in the blockchain, therefore the blockchain returns to the original NFT or NIL blockchain design that was selected or produce by the vendor, artists or team, etc. The “Play of the game NFT” are immediate memorabilia by designed, therefore are worth more than instant memorabilia or the traditional memorabilia conversion from the NFT mementos, from the NIL mementos or from souvenirs.

Another advantageous of the invention is that the “play of the game NFT” memorabilia is not picked by a random selection process like the souvenirs and NFT mementos are, or NIL mementos. The “play of the game NFT” commemorates the memorable moment of the event or game, may or may not be indicative of the final winners and losers. Furthermore, one or multiple fans may be asked to select the Play of the game NFT. Additionally, the player of the game NFT may be selected by the audience for example, pictures selection inputs. For example, after the completion of the game the audience waits for the selected pictures selection and the audience votes on the play of the game NFT. The goals for the “play of the game NFT” may or may not be for statistical correction but more for memorable representation of the event. The “Play of the game NFT” is also registered by the new owner or owners. In the same smart phone computer application the betting, waging for the acquisition of the “Play of the Game NFT” can be accomplished. The “Play of the Game NFT” revenues can be shared by all competitors for the designate event, or by the facility of the event, or charity, may be given to one winner only, or may have set percentages for the winning and losing team, and may be alter by authorized contract officials.

Another advantageous of the invention is to provide a method and system of the invention teaches a streamline approach to participating in the NFT arena, since most people do not know about NFTs, do not own a NFTs, having minted a NFT, having never participated in a community of NFT products, having never staked a NFT, having missed on building, or playing for NFTs like (BAYC, PUNKS, COOL CATS, and etc., wherein (Gas fees, and fees up front) or minting a random output on demand which shuffles the mint cost onto the buyer. Let's consider 90% of attendees keep their beverage containers as souvenirs, with the potential for memorabilia status. For example, each year in a lottery system the beverage containers are selected for NFT or NIL memorabilia status. Attendees of the event will retain their beverage container knowing every year they have a chance for their beverage container to have NFT or NIL memorabilia status. It is important to understand these collectibles are unique (never the same design) for every event and every consecutive event will have consecutive lottery number selection for NFT or NIL memorabilia status. Collectors will be able to put hundredths of the beverage containers in one shoe box size container. The general public will collect the beverage containers for the sentimental souvenir. In other words, their first concert, their first date, their 40 sports events. In other words, for the first-time beverage containers will not be treated as trash. Furthermore, the owners will have potential celebrity status during the lottery ceremony that takes place yearly or through a raffle random process the winners may have backstage visit with their favor artist, or team etc.

Another advantageous of the invention is to provide a beverage container, which allows the owners of the physical beverage container collected their beverage containers, while the beverage containers are marked with one or more physical markers like, barcodes, QR codes, Data Matrix Codes, PDF417, chipped, watermark, phosphorescent marking, stamping, any traditional color ink or dye, scan, laser, branded, chemical marking, imprint marking, casted framed, and or micro-doting. Any group consisting of unique product identifiers, physical numeric mark, a square code, a barcode, a laser mark, a print, a watermark, a luminescent mark, a chemical reactive mark, a chip, a tag, conceal scratcher, UPC, EAN, JAN, ISBN, Brand, and any MPN.

Another advantageous of the invention is to provide a physical souvenir beverage container with a function that can become a NFT souvenir after the original function is terminate. And when transferring, gifting, selling, or purchasing a physical beverage container, there is added value to keeping the physical merchandise that continues to have the potentials of becoming memorabilia through the yearly, and or monthly random drawing selection. The life collection of an individual or of a collective group can be sold, transferred, and traded in the invention as collage collection. In other words, an individual or a group can traded transfer and monetize any combination of souvenirs, NFTs or NILS mementos, NFT or NIL memorabilia, play of the game NFT or collage, wherein the amount of physical beverage containers are proportional to the number of blockchain digital work with the various different events, the distinctive locations and the combination of the souvenir, mementos, memorabilia or play of the game are within said collection, an individual or a group can traded transfer and monetize said collection as a collage. In another scenario the buyer may purchase the collage for one or more than one desired souvenir, NFT memento, NIL memento, NFT memorabilia, NIL memorabilia or “play of the game NFT”.

Another advantageous of the invention is to provide a beverage container with NFT and NIL tokenization, wherein the establishment benefits from the yearly guest ceremonies, wherein guest may or may not participate in the random draw ceremony, where the past winning numbers are now showed with the owner's personal story. In other words, children and adults become celebrities, for a day. They get to express why they are fans and connects with the other guest as they are provided their NFT or NIL memorabilia certificate and during the ceremony they draw the next year lottery winning numbers, providing the next year winners 11 months to provide proof of ownership, for the next year memorabilia winner. The goal is for guests to become participants and not just spectators, where we all contribute to reduce waste production and stop looking at beverage containers as trash. It is important to mention that the same principle can be applied to other desired behavior modifications, for other current or future trash items, culture bias and or desire outcomes. In other words, the invention can apply to any beverage container, manufacture product, unwanted disposable, recyclable material, or non-recyclable materials. Within the random process for selecting the random winning numbers the process can be done by any authorized individual or group for converting souvenirs and mementos into memorabilia, for example a fan, player, coach, and or the team. Furthermore, winning numbers can be pre-manufactured on to the item. In other words, the item (souvenir) may be manufactured with the preselected winning numbers, just like the current California lottery scratches, wherein the user will require to uncover set numeric code and or us a smart phone app to identify if said souvenir identification Number are the Winning numbers for an instant memorabilia price. It is important to mention the process of the smart phone app also enables the souvenir owner to register the item and to digitize any photograph on demand, to create the NFT memento or NIL memento. Additionally, a list of available NFT marketplaces will be operated within said invention of converting a souvenir into a NFT memento (blockchain). It is important to mention that the ceremonies are flexible. They may be performed independent of the games or (in-concert within the game ceremonies), or in the event from which the consumer purchased the beverage container in augmented reality AR, virtual reality VR, mixed reality MR, or extended reality XR, and etc., Additionally, the “play of the game NFT” can be on pre-sale before the final score, during the competition wherein the odds are favorable for generating the most value in the sale of the “play of the game NFT”, including outside international purchasing capacity.

Another advantageous of the invention is that any authorized souvenir (item) can be converted into a NFT memento and once the souvenir has been converted to a NFT memento and the NFT processed has been completed within the authorize NFT marketplace, the NFT memento may or may not have additionally digital changes in the smart contract (block chain), with or without customization items. In other words, at this point the souvenir original design blockchain is created or release to owner and alterations can be made to the original design, like Photos, different other NFT combinations, font changes, color modification, size changes, any customization or alterations different from the original design. It is important to mention that the same process is for the NIL mementos and NFT mementos, they both have a yearly opportunity to become memorabilia through the random selection process as mentioned for the souvenir. After the NFT mementos or NIL mementos are created they can now be viewed in the web/internet, social media with or without customization.

Another advantageous of the invention is to provide a beverage container with NFT and NIL tokenization, which most meaningful contribution is NFT digital customization and changes optional to the current owner at any time, with the same option to any new owner. The record of the chronological changes without alternating damaging the physical original NFT digital design. NFT is a living creation not just one of kind in a sea of others, but also a record of the input, customized and altered created by the current owner and past owners, where edits and customization may or may not be deleted or erased. In other words, who owned that NFT/NIL what did he/she altered, did the customization add or subtracted to the value of the NFT/NIL and most important what can the new owner add to the Customization of the NFT. Perhaps the original un-edited not altered NFT/NIL is worth more. Or perhaps the ownership and inscriptions customized added to the NFT/NIL makes that particulate blockchain priceless.

Another advantageous of the invention is to provide a smartphone application program from start to end, to enable the purchase of said item (souvenir), within the same program application the user may identify if the souvenir is an instant winner to memorabilia. The program application automatically registers said owner and allows for editing and customization for an authorized NFT marketplace operation for conversions of a souvenir to a NFT memento or to MIL memento. If the souvenir is an instant winner the conversion from souvenir to memorabilia is done automatically with or without physical certification of the souvenir, the original design (blockchain) for the set product is automatically digitized with or without customization done on the smartphone, or any other computing device operating said computer application, any additional changes to the original design, by the owner after the winning period, the owner may or may not have to pay the cost, any conversion from an item (souvenir) to a NFT/NIL memento is paid by the owner. Through the smartphone computer application, the user can buy, and sale said NFT/NIL products with or without customization. Furthermore, the computer application is able to connect to social medial platforms for the process of bragging, sharing selling and discovering ownership of said NFT/NIL products.

Another advantageous of the invention is to provide a method and system for any physical item to procure monetary value while providing a function, a personal connection or an emotionally circumstantial attachment. For example, NIL products like signing autographs products, social media clips, other custom apparels including other digital products like NFT, and crypto products can be incorporating, edited, or attached to the NTF according to the invention, therefore, making this NFT, “The Primary NFT”. In other words, the invention provides the value of the primary NFT and the exclusive use within the primary NFT in relation to other NFT products to increase and maintain the monetary value of the primary NFT in the invention. The primary NFT requires exclusivity by the customer, and by the NFT community to execute intellectual property standers superimposed on other physical products like custom apparels and digital products like other NFTs, NILs or crypto products operating now or in the future. In other words, the invention can have other NFTs with or without other NILs components, and other NFT products may or may not display said physical images on the beverage packet, or NFT play of the game. Preferably, after the consumer purchases an item, the consumer uses a NFT Marketplace for communication through a computing device like smartphone to create a physical contract and therefore creates a NFT in association with the purchase item or gift. For example, the beverage container purchased by a couple years ago during their first date as they attended their high school homecoming football rivalry and they continue having possession of the container, now the husband gifts his wife a meaningful memento, by creating a NFT memento out the original beverage container, in other words, the souvenir purchase. It is importantly mentioned, another goal of the invention is for a natural behavior change wherein the public desires to participate and purchase physical items that have blockchain technology for improving or reducing an undesirable practice “waste pollution”.

Another advantageous of the invention is to provide additional wining prices to enhance the experience, to add value to the creation of this invention. For example, the souvenir or NFT/NIL mementos may have a winning identification mark for other prices like backstage access, VIP photo session, vacations and other gifts, and etc., It is possible that the additional winnings are changed, yearly, monthly, for every event to improve public participation or to reinforce the value of keeping the physical items with or without blockchain technology. For example, through another random process, the additional winning prizes may be given to any souvenirs that were registered five years ago and have not been selected for memorabilia status. Or, the additional winning prizes may be instant prizes selected in every concert, game and etc., It is important to mention that the additional winning prices can be independent or in conjunction with the random selection process of any souvenir to memorabilia status, including blockchain technology.

Another advantageous of the invention is to provide a beverage container being any item purchased at first and through a digital (Blockchain) process producing a NFT memento creation (smart contra). Therefore, the NFT memento is produced on a blockchain with a micro-program (smart contract) in any digital form with any NFT/NIL autograph, alteration, attachments, pictures editing, pomes, coloring, wording, graphics, design, animation, etc. Therefore, the digital alterations is/are interlinked to the physical original item purchased and acquired. For example, the beverage container originally, as a souvenir, is created into an NFT memento (personalized) with a picture of the football signed (NIL) or digitally recreated together. Furthermore, the item has the yearly potential to be picked in a random selection for elevating the exclusivity of the (item) to memorabilia status.

Another advantageous of the invention is to provide a method and system for an open or close beverage container.

Another advantageous of the invention is to provide a method and system for a close air-thigh beverage container.

Another advantageous of the invention is to provide a method and system for an open or close beverage container that is collapsible.

Another advantageous of the invention is to provide a method and system for an open or close beverage container that is flexible.

Another advantageous of the invention is to provide a method and system for an open or close beverage container that requires less storage space.

Another advantageous of the invention is to provide a method and system for an open or close beverage container that requires less waste space.

Another advantageous of the invention is to provide a method and system for an open or close beverage container with substantial less plastic material.

Another advantageous of the invention is to provide a method and system for an open or close beverage container with substantial less paper material.

Another advantageous of the invention is to provide a method and system for an open or close beverage container with substantial less aluminum material.

Another advantageous of the invention is to provide a method and system for an open or close beverage container with insulation from the environment temperature.

Another advantageous of the invention is to provide a method and system for an open or close beverage container with more than one layer for temperature control of the contents in the beverage container.

Another advantageous of the invention is to provide a method and system for an open or close beverage container with more than one layer for structural support.

Another advantageous of the invention is to provide a method and system for an open or close beverage container, wherein the material in used are more biodegradable.

Another advantageous of the invention is to provide a method and system for an open or close beverage container with the capacity for pre-filling.

Another advantageous of the invention is to provide a beverage packet with a drinking arrangement, which is a hygiene product to normally seal around an area where the user's lips touching the beverage packet.

Another advantageous of the invention is to provide a beverage packet with a drinking arrangement, wherein not only the opening of the beverage packet but also a drinking tool are normally scaled and enclosed by the sealing flap for hygiene purpose.

Another advantageous of the invention is to provide a beverage packet with a drinking arrangement, wherein the drinking tool, such as a drinking biodegradable straw, stander straw or a mouth piece, can be built-in with the beverage packet and sealed by the sealing flap so as to keep the drinking tool clean and to prevent any loss of the drinking tool before it is used.

Another advantageous is the invention containers require much less material than the conventional beverage containers.

Another advantageous of the invention is to provide a beverage packet that the cubic space dimensions collapse as the product in the packets is being used.

Another advantageous of the invention is to provide a beverage packet with a zip-lock seal at the rim for closing the open beverage container.

Another advantageous of the invention is to provide a beverage packet with an adhesive over the zip-lock seal for closing the open beverage container.

Another advantageous of the invention is to provide a beverage packet which is a flexible container where the shape can mold to the external environment requirements as it is being consume and after consumption.

Another advantageous of the invention is to provide a beverage packet with a drinking arrangement, wherein no expensive or complicated actions are required by the user to employ in the invention. Therefore, the invention successfully provides an economic and efficient solution for providing a simple sealing and hygiene configuration for the beverage packet.

Another advantageous of the invention is to provide a beverage container that significantly reduces current plastic, aluminum and paper material requirements for bottling.

Another advantageous of the invention is to provide a beverage container that is beneficial to reduce landfill spaces, cans, glass bottles, plastic bottles, paper containers.

Another advantageous of the invention is to provide a beverage container having a low manufacture cost and requiring limited quantity cubic space.

Another advantageous of the invention is to provide a beverage container that reduces freshwater utilization by not having to repeatedly wash cups, glasses, and or mugs.

Another advantageous of the invention is to provide a beverage container with unlimited sizes and shapes.

Another advantageous of the invention to provide a flexible beverage container which is able to change to multiple shapes for more accommodating storing requirements.

Another advantageous is to provide a beverage container which is a business/credit card size packet or smaller, wherein the opening pouch opening is re-sealable and cover by the sealing flap.

Another advantageous of the invention is to provide a method and system for numerical numbers, Roman numerals,

Another advantageous of the invention is to provide a method and system for Asian numbers for serial numbers coding.

Another advantageous of the invention is to provide a method and system for various letters, symbols for serial number coding.

Another advantageous of the invention is to provide a method and system for the “play of the game NFT” memorabilia.

Another advantageous is to provide a method and system for stimulation for behavior modification for beverage containers to become collectibles.

Another advantageous is to provide a method and system for any physical item (souvenir) with Identification mark to qualify for a random process that gives memorabilia status to the selected physical item when the identification mark is selected.

Another advantageous of the invention is to provide a method and system for any sport related memorabilia.

Another advantageous of the invention is to provide a method and system for any physical souvenir or item to become memorabilia.

Another advantageous of the invention is to provide a method and system for any concert related memorabilia.

Another advantageous of the invention is to provide a method and system for any social congregation memorabilia.

Another advantageous of the invention is to provide a method and system for utilization for any political statement.

Another advantageous of the invention is to provide a method and system for utilization for any political congregation.

Another advantageous of the invention is to provide a method and system for air-tight collectable beverage container (packet or bag) with seasonal yearly designs, one-of-a-kind designs in a blockchain (NFT/NIL memento), interchangeable photos, different looks for memorabilia, and “The play of the game NFT”, graphical improvement, originality and customization.

Another advantageous of the invention is to provide a method and system for past historical ownership, sale prices, and a synapsis of how this item come to the (NFT) market.

Another advantageous of the invention is to provide a method and system for blockchain customization, for creativity and a synapsis of previous customization.

Another advantageous of the invention is to provide a method and system for individuals to add, enhance, or alter said digital products with permission, with the ownership of the physical beverage drink or without ownership of the physical beverage container.

Another advantageous of the invention is to provide a method and system for fractionalization of previous and future products.

Another advantageous of the invention is to provide a method and system for the blockchain and proof-of-work verification.

Another advantageous of the invention is to provide a method and system for brand customization of the beverage container.

Another advantageous of the invention is to provide a method and system for strict uniqueness.

Another advantageous of the invention is to provide a method and system for the micro-program (smart contracts).

Another advantageous of the invention is to provide a method and system image store on peer-to-peer (IPFS) and or TORRENT.

Another advantageous of the invention is to provide a method and system for Copyright, Commercial permission, A digital file, Bragging rights.

Another advantageous of the invention is to provide a method and system for images stored on servers like (HTTP).

Another advantageous of the invention is to provide a method and system for the smart contract for the token to have the/a function that defines royalties.

Another advantageous of the invention is to provide a method and system for obfuscate key phrases within the Ul and or uses at less two factor authentication.

Another advantageous of the invention is to provide a method and system for each transaction that computes or alters information require to interlinked and reference each other.

Another advantageous of the invention is to provide a method and system for a timepiece for art to reflect the sign of the time, social, political changes, sport memorabilia and social struggles.

Another advantageous of the invention is to provide a method and system for name, images or the likeness (NIL) of athletes to produce revenue.

Another advantageous of the invention is to provide a method and system for name, images or the likeness (NIL) of non-athletes to produce revenue.

Another advantageous of the invention is to provide a method and system for smart contracts with the (NIL) contracts, standardize, or individualize.

Another advantageous of the invention is to provide a method and system for an ordinary souvenir, becoming a memento and a memento becoming memorabilia with or without (NIL), with seasonal yearly designs, one-of-a-kind designs in a blockchain (NFT).

Another advantageous of the invention is to provide a method and system for any NIL outside of sports like music, creative arts to become memorabilia.

Another advantageous of the invention is to provide a method and system for a platform of blockchain technology with physical items, for the sale and purchase of both or either.

Additional advantages and features of the invention will become apparent from the description which follows and may be realized by means of the instrumentalities and combinations particular point out in the appended claims.

According to the present invention, the foregoing and other objects and advantages are attained by a beverage container which comprises a beverage packet and a drinking arrangement.

The beverage packet includes a first bag wall and a second bag wall defining a beverage cavity between the first and second bag walls. The beverage packet further has an enclosable area defined at the first bag wall and a drinking opening formed within the enclosable area.

In one embodiment, the beverage packet includes one or more layers of plastic wall and one or more layer of absorbent material wall separating the beverage cavity.

In one embodiment, the beverage packet includes two or more layers of plastic wall air-seal airtight around one or more layers of absorbent material wall that are separate from the beverage cavity.

In one embodiment, the beverage packet includes two or more layers of plastic wall air-sealed and airtight around one or more layer of absorbent material wall with a build-in valve for introducing liquid to be uniformly absorbed by the said absorbent material.

In one embodiment, the beverage packet includes two or more layers of plastic wall air-seal/airtight around one or more layer of absorbent material wall with a built-in valve for activating liquid to be uniformly ice/crystallize by liquid nitrogen.

In one embodiment, the beverage packet includes two or more layers of plastic wall air-sealed and airtight around one or more layer of absorbent material wall with a build-in valve for introducing a vacuum pump for removing air pressure between the two layers of the plastic wall air-seal/airtight and allowing the water buoyancy disbursement to give the said walls shape and rigidity.

In one embodiment, the beverage packet defines a cavity between the first and second bag walls. The beverage packet further has an enclosable area defined at the first bag wall and a drinking opening formed within the enclosable area.

In one embodiment, the drinking arrangement includes a sealing flap extended from the second bag wall and folded on the first bag wall to enclose the enclosable area thereof so as to seal the drinking opening by the sealing flap, wherein the sealing flap is unfolded from the enclosable area to unseal the drinking opening.

In one embodiment, alternatively, a product bag, as a replacement of the beverage packet, includes a first bag wall and a second bag wall defining as a product pouch cavity between the first and second bag walls. The product bag further has an enclosed area defined at the first bag wall and pouch like opining formed within the enclosable area.

In one embodiment, alternatively, the product bag, as a replacement of the beverage packet, includes a first bag wall with two or more plastic air-seal/airtight walls encasing an absorbent, wherein said walls have a build-in valve of the same plastic wall and another second bag wall identical in dimensions to the first bag wall is superimposed and sealed to produce the beverage cavity, wherein the inner first bag wall and another inner second bag wall produce the beverage cavity with the exception of the extension flap that continues from the second bag wall and when the inner bag wall of the second bag is folded over onto the outer first bag wall, the outside of the first bag wall and the second bag walls produces the product pouch cavity. The product bag further has an enclosed area define at the first bag wall and pouch like opening formed from the second bag wall extension flap.

In one embodiment, the seals can be chemical, natural substances, mechanical, physical, and/or electrostatic attraction of plastics, or any additional Food And Drug Administration (FDA) modality that are approved for coming in contact with the mouth and with oral products for human consumption.

In one embodiment, it utilizes existing materials and technology for the production of the beverage packets in accordance with the (FDA).

In one embodiment, the method and system for the beverage containers provide an additional value as a memento and not just a souvenir.

In one embodiment, the method and system for the beverage containers allow the physical item the beverage container to become memorabilia after the beverage container is selected by any random process.

In one embodiment, the method and system for the beverage containers allow the beverage containers as a collectible and not as a waste product.

In one embodiment, the method and system are adapted for any item having authentication security code, also requiring registration, wherein the system provides the item as a collectible and not as a waste product.

In one embodiment, the method and system for beverage containers enable the (souvenir) owners to produce a Primary NFT, wherein the system provides the beverage container the capacity to alter, edit, and change the smart contract digital work.

In one embodiment, the method and system for beverage containers is configured with a security code, wherein the system provides the beverage containers with the capacity to alter, edit, and change to produce a primary NFT.

In one embodiment, the method and system for beverage containers enable the beverage container to get register, wherein the system provides said beverage containers with the capacity to alter, edit, and change to produce a primary NFT.

In one embodiment, the method and system for beverage containers allow the beverage containers with the capacity to alter, edit, and change to produce a primary NIL.

In one embodiment, the method and system for beverage containers enable the beverage containers being NIL products, wherein, multiple beverage containers are collapsible flexible, and foldable highly adaptable for condensed storage.

In one embodiment the method and system for beverage containers enable the beverage containers as one or more type of collectable, souvenirs, memento, or memorabilia or play of the game. In other words, said beverage container (item) may have all four designations in their life span.

In one embodiment, the method and system for beverage containers allow the beverage containers having a ranking value for all types of collage collectables, souvenirs, mementos, or memorabilia, or play of the game.

In one embodiment, the method and system for beverage containers allow the beverage containers having a ranking emotional system between a souvenir and a memento with a purchase of a beverage drink. Furthermore, the owner of that beverage container can convert that beverage container into a personal NFT memento or NIL memento.

Additionally, the souvenir or the memento beverage container have future possibilities of becoming memorabilia.

In one embodiment, the method and system for beverage containers substantially helps to reduce waste production of beverage containers in landfills.

In one embodiment, the beverage container is configured to allow the general public to carry more than two beverage containers without additional waste in material from the cup carrier.

In one embodiment, the method and system for beverage containers allow the general public to have a faster purchase transaction reducing the pouring time for filling beverage containers.

In one embodiment, the method and system for beverage containers allows the general public to have less waiting time for beverage purchases and have more quality time in the event.

In one embodiment, the method and system for beverage containers allow the general public has a system for monetizing beverage containers.

In one embodiment, the method and system for beverage containers with blockchain technology allow the general public having a system for monetizing smart contracts digital work.

In one embodiment, the method and system for beverage containers allow the general public can use less material of plastic and aluminum for a single beverage container.

In one embodiment, the method and system for beverage containers allow the general public has a system for flexible collapsible beverage containers that are souvenir.

In one embodiment, the method and system for beverage containers allowing the general public pre-filled beverage containers.

In one embodiment, the method and system for beverage containers allow the general public can store said packets with limited storage requirements, before and after filling.

In one embodiment, the method and system for beverage containers allow the general public to further monetize the souvenirs, mementos and memorabilia with signatures/autographs.

In one embodiment, the method and system for beverage containers allow the general public can store said digital designs in a blockchain format, with or without the physical beverage container.

In one embodiment, the method and system for beverage containers allow the general public using industrial-standard cryptographic (SSL/TLS and PGP).

In one embodiment, the method and system for beverage containers allow the general public use of numerical numbers, Roman numbers, Asian numbers or any other form of computable identification markings for serial coding.

Still further objects and advantages will become apparent from consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a schematic view illustrating various recycled waste.

FIG. 2A and FIG. 2B are schematic views illustrating a beverage container according to a preferred embodiment of the invention, wherein the beverage container is in open or close with absorbent material within air-seal/airtight bag walls with any dispensing apparatus.

FIG. 3 is a schematic view illustrating the beverage container according to the preferred embodiment of the invention.

FIG. 4A and FIG. 4B are schematic views illustrating an alternative mode of the beverage container according to the preferred embodiment of the invention.

FIG. 5 is a schematic view illustrating an alternative mode of the beverage container according to the preferred embodiment of the invention.

FIG. 6 is a sectional view of the beverage container a according to the preferred embodiment of the invention.

FIG. 7A to FIG. 7B are sectional views illustrating the outer layer and inner layer of one wall bag air-seal/airtight with absorbent and valve function of the beverage container according to the preferred embodiment of the invention.

FIG. 8 is a schematic view illustrating manually or mechanically/robotic the mold which is positioned into the empty beverage container before using the vacuum pump and/or liquid nitrogen according to preferred embodiment of the invention.

FIG. 9 is a schematic view illustrating the scalability of the beverage container according to the preferred embodiment of the invention.

FIG. 10 is a schematic view illustrating an automative system production of the beverage container according to the preferred embodiment of the invention.

FIG. 11 is a schematic view illustrating the tokenization of various beverage containers according to the preferred embodiment of the invention.

FIG. 12 is a schematic view illustrating the tokenization of various beverage containers according to the preferred embodiment of the invention.

FIG. 13 is a schematic view illustrating the computerization of activating the blockchain process of various beverage containers according to the preferred embodiment of the invention.

FIG. 14 is schematic view illustrating physical product of beverage container converted to (NFT or NIL) digital product according to preferred embodiment of the invention.

FIG. 15 is a schematic view illustrating pathways for any beverage container with or without NFT and NIL to become a computer digital work in the blockchain process according to the preferred embodiment of the invention.

FIG. 16 is a schematic view illustrating multiple exclusivities according to the preferred embodiment of the invention.

FIG. 17 is a schematic view illustrating a ranking system for collectible NFTs and NILs according to the preferred embodiment of the invention.

FIG. 18 is a schematic view illustrating the collection of NFTs and NILs along with the beverage containers according to the preferred embodiment of the invention.

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

In the description of the present invention, unless explicitly stated otherwise and qualified, terms such as “connected,” “attached,” and “fixed” should be construed broadly. For instance, these terms may indicate a permanent connection or a detachable one, or they may refer to a whole unit. They can signify a mechanical linkage, an electrical connection, direct coupling, or indirect interaction through an intermediary medium. Whether these terms imply an internal connection between two elements or an interactive relationship between them will depend on the specific context and the understanding of those skilled in the art.

Throughout this invention, unless explicitly stated otherwise and qualified, when the first feature is described as being “above” or “below” the second feature, this may entail direct physical contact between the two features. Alternatively, it may signify that the first and second features are not in direct contact but are linked through the involvement of additional features. Additionally, the description of the first feature being “above,” “over,” or “on top of” the second feature includes scenarios where the first feature is positioned directly above or diagonally above the second feature or simply means that the first feature is situated at a higher horizontal level than the second feature. Conversely, when the first feature is referred to as “below,” “under,” or “beneath” the second feature, it encompasses cases where the first feature is directly below or diagonally below the second feature or simply implies that the first feature's horizontal height is less than that of the second feature.

In this embodiment's description, terms such as “up,” “down,” “right,” and “left” are used to describe orientations or positional relationships. These descriptions are based on the orientations or positions depicted in the drawings and are employed for ease of explanation and simplification of operation. They should not be construed as indications or implications that the device or element being discussed must possess a specific orientation, be constructed in a particular manner, or operate exclusively in a certain orientation. Furthermore, terms such as “first” and “second” are employed solely for the purpose of distinction in the description and do not carry any particular significance.

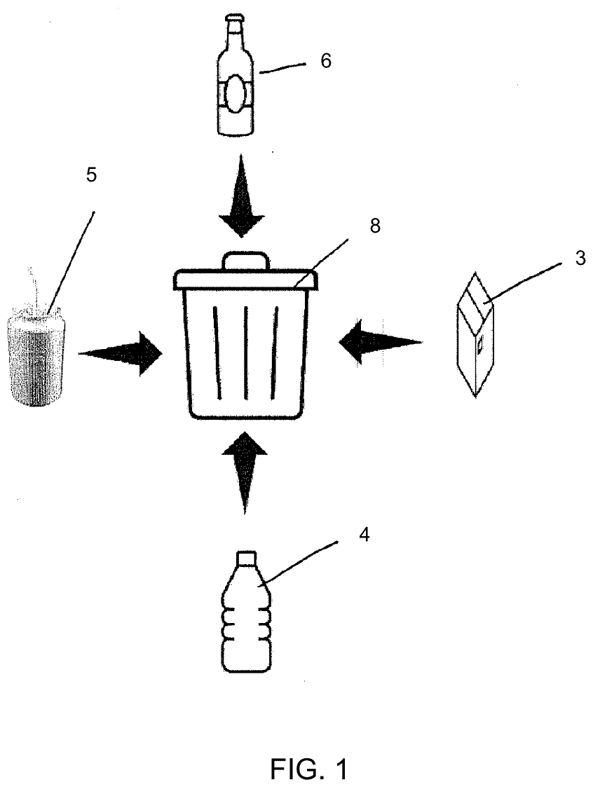

FIG. 1 illustrates various waste produced yearly in the United States, wherein about 292.4 million tons of beverage container waste made of paper 3, plastic 4, aluminum 5, and glass 6 be disposed yearly, wherein only 69 million tons of them is recycled. It shows the problem of waste production in the U.S. surpasses current mitigating efforts with recycling and it is not working. We recycle less than a quarter of the single beverage containers we use. The single beverage containers continue to be produced with more than the raw material required for a single serving beverage that will be consumed in a timely manner. The invention utilizes significantly less paper 3, plastic 4, aluminum 5, and glass 6 for the production of a beverage container. According to the preferred embodiment, the invention teaches significant less about of paper 3, plastic 4, aluminum 5, and glass 6 that will not end-up in the waste disposal 8 from the current beverage container manufactures. Furthermore, the paper beverage container 3, the plastic beverage container 4, the aluminum beverage container 5, and the glass beverage container 6 are past recycle material and the amount of paper 3, plastic 4, aluminum 5, and glass 6 used in the production of the beverage container are significantly reduced. The invention discloses the production of the most biodegradable beverage container for a single beverage serving, to be consumed in a timely manner. Furthermore, current beverage containers are created for one hand usage, one hand grasping, this greatly reduces the ability for one person to carry more than two beverage containers, one for each hand. Therefore, carry-on cup containers require additional more paper or plastic waste production to be manufactured. Furthermore, the time it takes to pour each beverage and to secure each container into the carry-on cup container is valuable time away from the friends and love once, affecting the most valuable times away from the entertainment, family and friends.

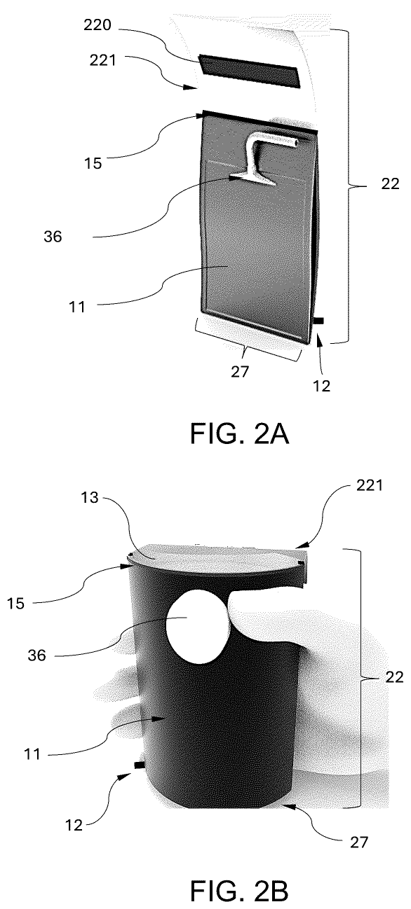

Referring to FIG. 2A and FIG. 2B, a preferred embodiment of the present invention is illustrated. Beverage containers such as portable flexible beverage bags 22 in open or close state are illustrated. The beverage bag 22 is illustrated to have any type of dispensing apparatus 36, for example straw, bottle cap, ziplock 15, or sprayer. Additionally, the beverage containers may have an extending beverage flap 221 and the beverage flap 221 can be removed or not position over the ziplock 15. The beverage flap 221 is used for reducing contaminants exposure on the dispensing apparatus 36, and also provides support for the beverage bag 22 not to slip from the user's hand, as illustrated in FIG. 2B. The dispensing apparatus can be made of plastic, wood, paper, glass, or any of the FDA material allow for mount and lip contact in relation to beverage and food consumption. Furthermore, the beverage bag 22 may have any type of bottom design, in relation to enabling the beverage bag 22 to stand on its own or not. For example, the beverage bag 22 that is intended to be carried in a backpack, the additional material required for self-standing bottom 27 the beverage bag 22 is not required. Furthermore, concerts, that are for the masses without a sitting area, are also ideal for beverage bags 22 without the additional material to be self-standing bottom 27. The invention discloses the beverage container industry every effort to produce a beverage bag 22 for reduce waste, by producing a collapsible bag wall 29, to reduce raw materials therefore is the beverage bag 22 becomes waste, the bag walls 29 of the beverage bag 22 will be the most biodegradable beverage container with the least waste space requirement. Referring to FIG. 2A, the beverage bag 22 is embodied as a close container with the consumption product within the interior of the beverage bag 22 enclosed by the ziplock 15, with any dispensing apparatus 36 after the ziplock is permanently close or not permanently close. Referring to FIG. 2B, the beverage bag 22 is embodied as an open container with the consumption product 17 within the interior of the beverage bag 22 surrounded by the ziplock 15, with any dispensing apparatus 36 after the ziplock 15 is permanently open or not permanently open.

The outer layer 11 has at least one display surface providing a surface area that the user touches, and the inner layer 13 of the wall bag is the surface area touching the consumption product 17 or part of the extension of the second bag wall producing the inner portion of the beverage flap 221 on the beverage bag 221, that creates the second pouch with the outer surface of the first bag outer layer 11 and housing any dispensing apparatus 36. It is important to mention the valve 12 of the beverage container can be positioned in any desired location of the beverage bag 11 by the manufacture and can be removed, open, or close for the feature function that will be outline later in the invention.

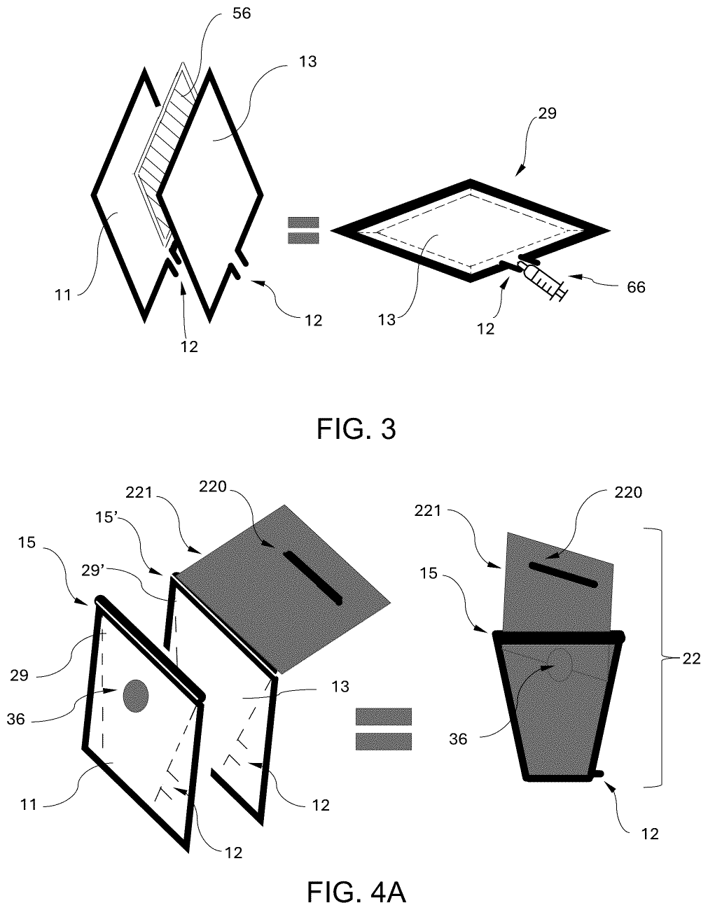

Referring to FIG. 3, according to the preferred embodiment, the portable flexible beverage bag 11 comprises container walls, i.e. two plastic layers, the inner layer 13 and the outer layer 11 surrounding an absorbent layer 56 and when both the inner layer 13 and the outer layer 11 are sealed along the edges, without sealing the extension dimension of the valve 12, that naturally produces an orifice between the inner layer 13 and the outer layer 11, within the valve 12. It is important to mention the seal between the inner layer 13 and the outer layer 11 are air-seal/airtight, with the exception of the valve 12. Furthermore, the valve 12 enables an orifice for the absorbent material 56 to be activated with any chemical reaction, that is inserted externally. The valve 12 also enables for any extraction of air pressure within the inner layer 13 and the outer layer 11, externally. Additionally, one bag wall 29 is produced by two or more layers of plastic, absorbent, paper, glass, or aluminum, in any arrangement layer combination within the layer. For example, the absorbent layer 56 may or may not extend the full length and width of the inner layer 13 and outer layer 11, the absorbent 56 layer may have combinations of paper, plastic, glass, or aluminum as necessary for the desired chemical reaction. Furthermore, any combination of material is possible for any additional layers or for the outer layer 11 and or the inner layer 13. In other words, the outer layer 11 may be transparent and the absorbent layer 56 may have the aluminum layer on the outside for displaying a pre-selected colorful design, vice versa the outer most layer superimposed on the bag wall 29 may or may not be the aluminum layer and that layer may have other combinations of paper, plastic, or glass. It is important to mention the absorbent 56 can be a layer medium of wood fibers, sponge like material, cotton fibers, gelatin crystals any other powder reactive to a solvent to produce a reaction, in any shape, length and width, or configuration. The valve connector 66 can introduce water, other solvents, solutes, air pressure, vacuum pressure into the air-seal/airtight space of the bag wall 29 additionally affecting the absorbent 56 layer.

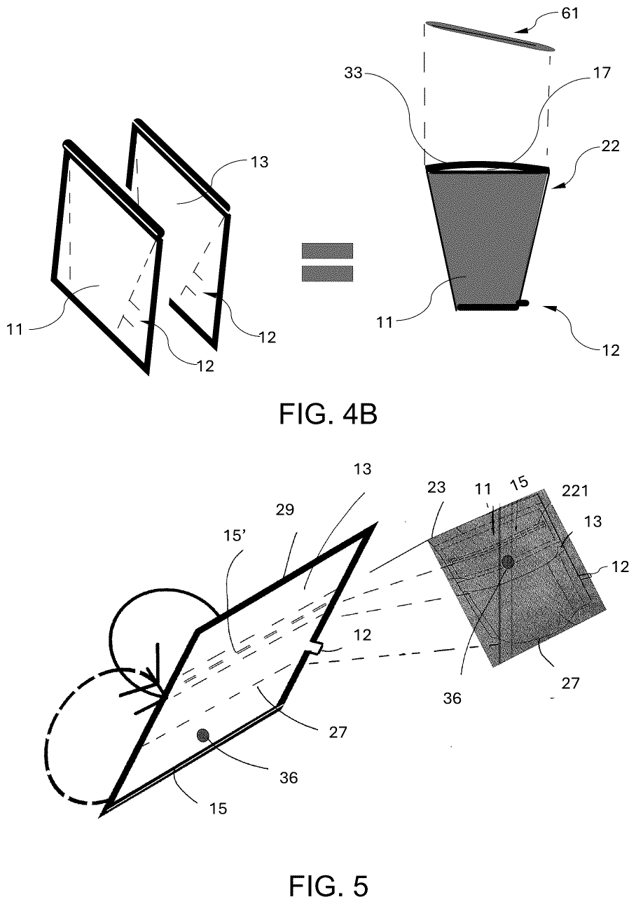

Referring to FIG. 4A, according to the preferred embodiment of the invention, two or more bag walls 29 cut and sealed accordantly for the production of a desire shape closed beverage bag 22 are illustrated, wherein the cutting and sealing of each bag wall are made to coordinate with more than one bag wall 29 as a mirror image allowing for each bag wall to have different accessories that provide synergy to more than one bag wall 29 once arrange properly and sealed. For example, one bag wall has the dispensing apparatus 36, while the other bag wall 29′ has the beverage flap 221 and once both inner layer 13 are face to face and precisely both are cut and sealed accordantly, to produce a beverage bag 22, with the dispensing apparatus 36 from one half, with the beverage flap 221 from another half and wherein both halves are sealed. The ziplock 15 product comes from two bag walls 29 to produce one fully functional apparatus, thereby all accessories from one or more than one bag walls 29 enhance the function of the beverage bag 22, as one item. Additionally, this example will help with production of said beverage bags 22 in a horizontal or vertical manufacture. In this example it is important to mention there are two valves 12, one for each bag wall 29 and that also means there are two orifices one for each valve 12. It is possible to create a valve connector 66 with two connections and function at the same time, as one unit valve connector 66.

Referring to FIG. 4B, according to the preferred embodiment of the invention, two or more bag walls 29 cut and sealed accordingly for the production of a desire shape an open beverage bag 22 are illustrated. It is possible to have a beverage bag 22 without any accessories with the exception of the container lid 61 to prevent dust cross-contamination. Furthermore, the container lid 61 can be of any material that is FDA approved.

Referring to FIG. 5, according to the preferred embodiment of the invention, one enlarge bag wall 29 is illustrated with the method and system of having accessories or partial accessories in designated locations pre-position for the folding to generating a close beverage bag 22 with the selected functions, wherein the bag wall folding starting from the bottom and finishing on top with the last fold of the beverage flap 221, thereby enclosing the dispensing apparatus 36 and during the process the right side and left side are sealed providing the beverage cavity 33 for the consumption product 17, therefore each fold is precise allowing for the functions including half of the ziplock 15′ and the other half of the ziplock 15 portion to be parallel with each other for full function.

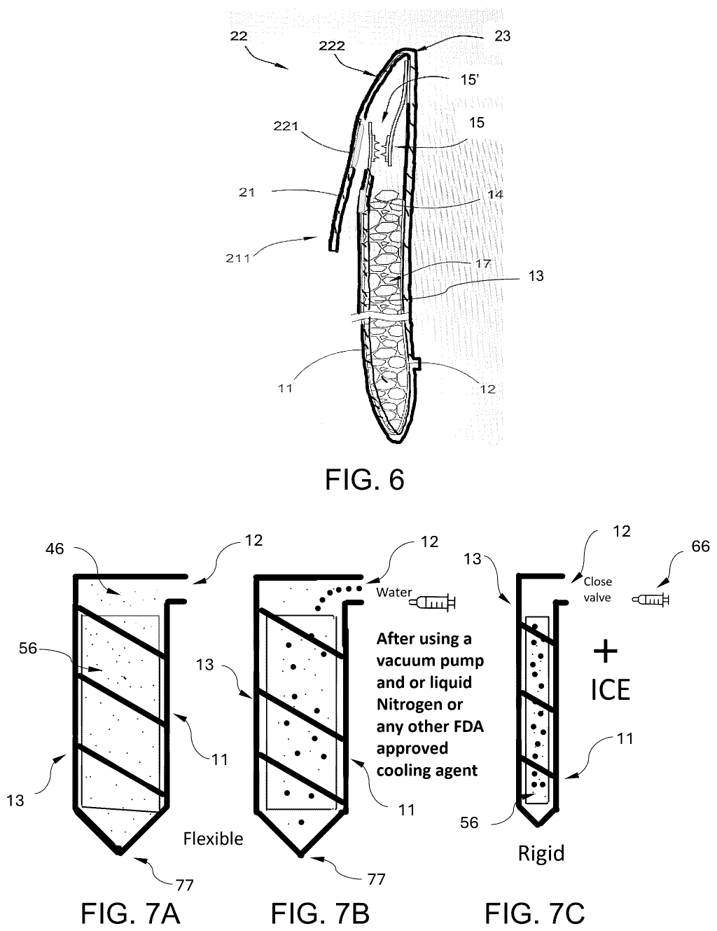

Referring to FIG. 6, according to the preferred embodiment of the invention, a cross section for various sizes produced from one bag wall 29 and not more than one bag wall 29 like illustrated on FIG. 4 is illustrated. Additionally, the one bag wall 29 has various product accessories for the production of a close or open beverage bag 22. FIG. 6 is an illustration of the final beverage bag 22 with all the folds as illustrated in FIG. 5 allowing the creation and the pre-selected location of various accessories in the beverage bag 22. For example, the first fold at the bottom creates the bottom of the beverage bag 22 and positions the dispensing apparatus 36 within the area of the future beverage flap 221 for enclosure. Additionally, the other half of the ziplock 15 apparatus is positioned at the same height as the other half of the ziplock 15′ for closing and opening of the beverage cavity 14 for filling of the consumption product 17, and for the sealer 220 on the inner layer 13 of the beverage flap 221 which may or may not make contact with the ziplock 15, and or with the dispensing apparatus 36, sealer 220 is an adhesive intended make contact with the outer wall 11 of the beverage bag 22. It is important to mention the absorbent 56 layer/medium is position anywhere, with any quantity, within the inner layer 13 and the outer layer 11 plastic bags air-seal/airtight seal. Additional layer 19 can be positioned outside the outer layer 11 or outside the inner layer 13. For example, additional layer 19 in this embodiment is illustrated as an aluminum layer for color graphic designs on the outside of the outer layer 11.

Referring to FIG. 7A to FIG. 7C, according to the preferred embodiment of the invention, cross sections for various sizes produced from one bag wall 29 or from multiple bag walls 29 are illustrated. The bag wall 29 illustrates the functions of the inner layer 13, the outer layer 11, the absorbent 56, the valve 12, and the valve connector 66 have in relation for various products close or open beverage bags 22. The valve connector 66 is the external connection to the function of the bag wall 29. For example, the bag wall 29 may be rigid, flexible, cold or insulated, through the operations of the valve connector 66, wherein the inner space 46, the absorbent 56 layer, the inner layer 13, the outer layer 11 are activated for a function. FIG. 7A illustrates the bag wall 29 with the inner space 46, the absorbent 56 layer, the inner layer 13, the outer layer 11, and the valve 12. The bag wall in its present condition is flexible without any operation from the valve connector 66. It is possible to activate the bag wall 29 through the valve 12 with the valve connector 66, wherein the valve connector 66 is a vacuum pump and thereby decreasing the air pressure in the inner space between the out layer 11 and the inner layer 13, Additionally, the absorbent layer 56 gets activated by being compressed. The compression of the absorbent 56 layer will provide rigidity to the bag wall 29 as the inner layer 13 and as the outer layer 11 compressed inward onto the absorbent 56 layer. It is important to mention the reduction of inner space 46 is due to the reduction of the air pressure within the air-seal/air-thigh connection 29 of the inner layer 13 and the outer layer 11. Additionally, the absorbent 56-layer space is also reduced due to the loss of air pressure within the inner layer 13 and the other layer 11. In this example, after the activation of the vacuum pump on the valve 12 the bag wall 29 will mimic the bag wall 29 as shown in FIG. 7C, with the exception of the water or ice contents. It is important to mention the additionally cooling agents like liquid nitrogen can also be introduce outside the bag wall 29 or inside the bag wall 29 through the valve 12. The cooling agent will reduce the temperature thereby reducing the air pressure within the bag wall 29 and will harden or not harden the absorbent 56 layer. The implementation of the vacuum pump and the cooling agent can be introduced at the same time and or independently in a timely manner, depending on the desire function of the bag wall 29 for the user type of beverage bag 22.

FIG. 7B illustrates the bag wall 29 is similar to FIG. 7A, with the exception that the valve 12 is being introduced with a liquid, or a solvent in this example the liquid or solvent is again provided through the valve 12 from the connection of the valve connector 66, wherein the valve connector may introduce the liquid and or solvent first and then the cooling agent or the vacuum pump action, or vice versa. It is important to mention this process may independently activate the absorbent 56 layer, the inner space 46 or the inner layer 13 and the outer layer 11. Furthermore, this process may activate the absorbent 56, the inner space 46 and the inner layer 13 and the other layer 11 at the same time or in a timely manner. For example, the water introduced by the valve connector 66 may active the gelatin absorbent in the absorbent 56 layer then a different valve connector 66 or the same valve connector 66 may have the capacity to be attached to a vacuum pump and furthermore, also the hose may be attached for introducing a cooling agent. Additionally, the cooling agent may be activated in the bag wall 29, with the absorbent 56, or through contact on the outside of the inner layer 13 and or through contact on the outside of the outer layer 11.

FIG. 7C illustrates the bag wall 29 after being activated by the vacuum pump, liquid or solvent and the cooling agent, or by a chemical reaction within the absorbent 56 layer. For example, as shown in FIG. 7B and FIG. 7C, an illustration of water within the bag wall 29 and mixing with the absorbent 56-layer material and the inner surface of the inner layer 13 and the outer layer 11 is provided, wherein the absorbent 56 layer is made of cotton fibers, synthetic fibers, any natural fiber, or man-made fibers like synthetic material. It is important to mention the air space reaction in relation to the inner layer 13, the outer layer 11 and the absorbent 56-layer composition and chemical reaction within the absorbent 56 layer for example gelatin powder, solids or any combination causing a change in the physical state of the absorbent 56 layer, within the inner space 46 of the inner layer 13 and of the outer layer 11 of the bag wall 29. In one example, the absorbent 56 layer is made with gelatin on one side facing the outer layer 11, while the absorbent cotton fiber faces the inner layer 13. The water is introduced by the valve connector 66 through the valve 12 and activates the gelatin within the absorbent 56 layer to expand and additionally the cotton fibers of the absorbed 56-layer absorbers the water molecules. Now consider using the valve connector 66 as a vacuum pump where the inner layer 13 and the outer layer 11 are compressed onto the absorbent cotton water and cotton gelatin, when the air space is reduced by the lost in air pressure. Now the inner layer 13 is activated with a cooling agent like liquid nitrogen that crystallizes the water molecules, produces ice without causing any changes to the consumption product 17 from the crystallization of the water or when the ice melts. Also, when the water turns to crystal (ice), there is further expansion on to the inner surface of the inner layer 13 and the outer layer gives further resistance to the gelatin buoyancy that was previously created from the vacuum pump usage. The benefits are the inner layer 13 close contact with the consumption product 17 to keep the consumption product 17 cool, wherein the gelatin expansion increases the water buoyancy between the inner layer 13 and the outer layer 11, where the tension is held by the airtight/air-seal connection 77 between the inner layer 13 and the outer layer 11. The accumulation of these action produces a rigid bag wall 29 for the beverage bag 22 where the gelatin in the absorbent 56 layer reduces the transfer of head onto the consumption product 17 and reduces the transfer of head onto the water crystallization (ICE). The consumer benefits from a rigid beverage container the keep their consumption product 17 cool for a longer period of time without any changes to the flavor or texture of the consumption product 17.

Additionally, the gelatin reduces the cool transfer to the outer layer 11 from the ice water crystallization produced when the inner layer 13 was exposed to the cooling agent liquid nitrogen in the portion of the absorbent 56 layer. At the end the beverage bag 22 consumption product 17 is finished and the beverage bag 22 loses the rigidity. The head is transferred throughout the bag walls 29 including the ice and gelatin formation in the absorbent 56 layer. Now the beverage bag is flexible and collapsible, built with the less amount of material as possible for a timely single beverage serving. Ideally the beverage bag is not trash to the consumer but if it is and that beverage bag is not recycled properly the biodegradability of this beverage container is a lot less than that of all current timely single serving beverage containers out in the current market. Also, the waste space is grammatically reduced for land waste disposal. And lastly all materials used in the beverage bag 22 from the glues, sealers, and dispensing apparatus 36 are non-toxic material.

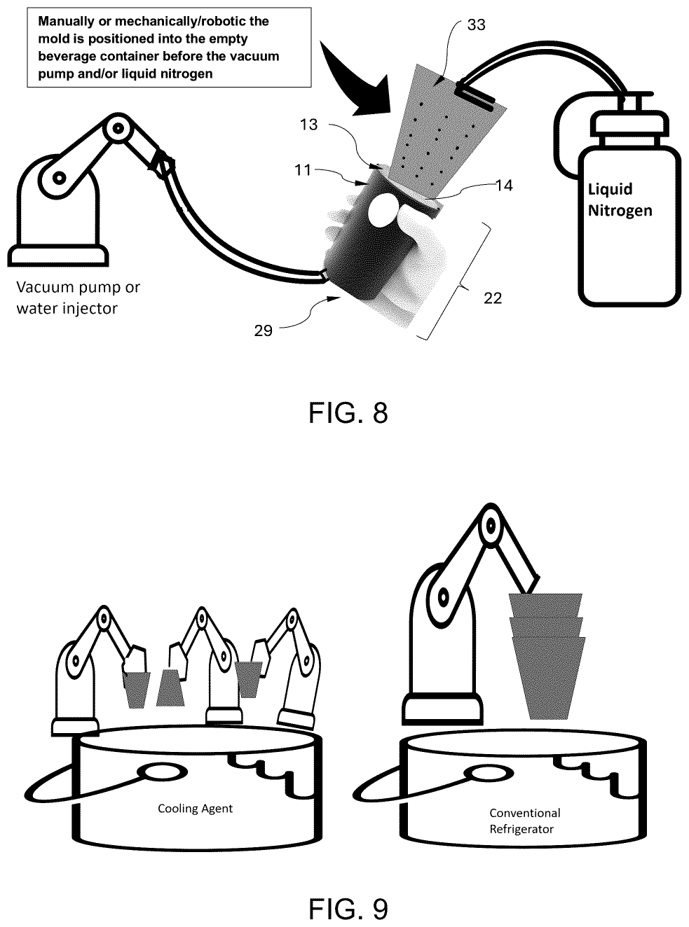

Referring to FIG. 8, according to the preferred embodiment of the invention, and utilization of various physical molds 38 for various beverage bag 22 size products for the structural molding of the one or more bag walls 29 for open or close beverage bags 22 is illustrated. FIG. 7A to FIG. 7C illustrate the method and system in relation to the processes within the bag walls 29. FIG. 8 illustrates the external manual, mechanical or robotic process for producing the desired beverage bag function and shape. In other words, the physical mold 38 gives the bag walls 29 various shapes for the beverage bag 22 throughout all the process described on FIG. 7A to FIG. 7C. Furthermore, the molds 38 may also be a source to deliver a heading agent physical or chemical and a cooling agent physical or chemical. Additionally, the molds 38 may have pores 33 for introducing the cooling agent or the heating agent on to the inner layer 13 of the wall bag 29 of the beverage bag 22. For examples, the cooling agent can be liquid nitrogen and for the heating agent it can be steam injected through the pours 33 in the mold 38 contacting the inner layer 13 of the bag wall 29 of the beverage bag 22. It is important to mention the cooling agent is not limited both the cooling and the heating agent can be utilize in various cycles for the process of producing the beverage bag 22 depending on the liquids, solvents, materials, glues, plastics, sponges, and fibers used in the beverage bag 22.

Referring to FIG. 8, according to the preferred embodiment of the invention, a scalability of various physical molds 38 for various beverage bags 22 of different sizes, shapes and composition products for the structural and activation of said various open or close beverage bags 22 is illustrated. It is important to mention the beverage bags 22 may have an undefined date of production, where the material of the beverage bag 22 is activated on demand or at a previous time before the consumption product 17 is put into the beverage cavity 14 of the open or close beverage bag 22. The scalability of activating the liquids, solvent, cooling agents, heating agents, the molds, and the chemical reactions within the composition of the beverage bag walls 29.

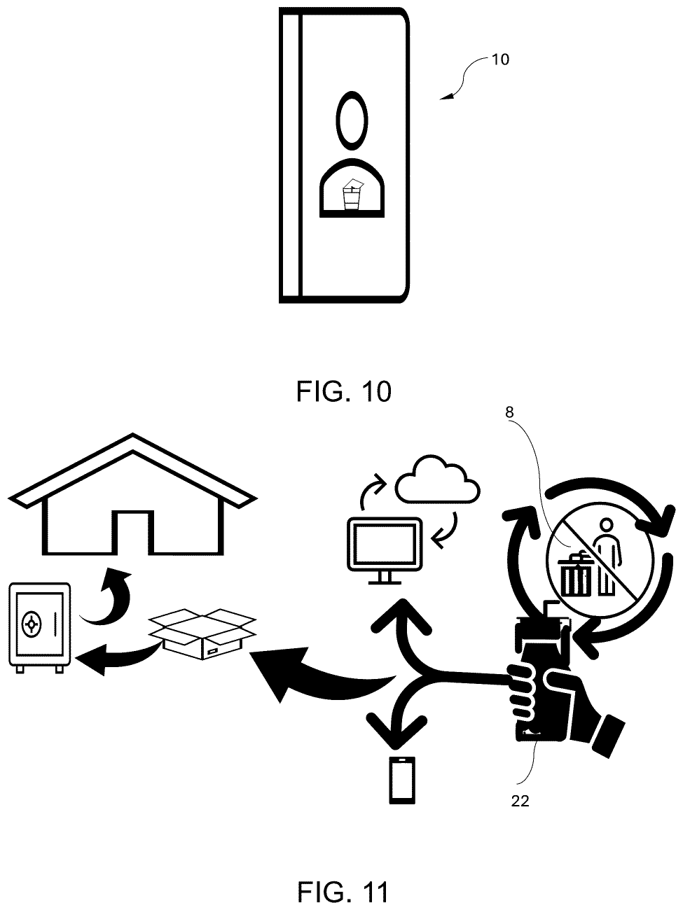

Referring to FIG. 9 to FIG. 10, according to the preferred embodiment of the invention, a scalability portability automative system production 10 of various beverage bags 22 of different sizes, shapes and composition products for the structural and activation of said various open or close beverage bags 22 is illustrated. FIG. 8 illustrates the manual, mechanical, and robotic process for activating the beverage bags 22. FIG. 9 illustrates the scalability for activating multiple beverage bags 22 open or close at the same time or in a timely manner. Consider the method and system mentioned in FIG. 7 to FIG. 9 for the activation of the beverage bags 22 on a single automotive system production 10 unit where the dispensing of the beverage bag is automotive or where the dispensing of the consumption product 17 is in the beverage bag 22 without any additional action from the vender or the user. It is important to mention the dispensing of alcoholic consumption products 17 can continue to be done by the vender after the completion in the process of activating the beverage bag 22. Additionally, another selected process, during the production of the beverage bag 22, may be manually performed by choice and not by any limitations within this invention. In other words, the method and system illustrate, from start to finish without limitations, providing a beverage bag 22 with the less amount of material for a single serving beverage container with the consumption product 17 or without the consumption product 17. Additionally, within the automative system production 10 unit for the beverage bags 22 the automative system production 10 unit may have the space for storing pre-activated beverage bags 22, post activated beverage bags 22, open or close beverage bags 22, without the consumption product 17 or with the consumption product 17.

This invention is ideal for space travel projects where no natural resources are available. No water to utilize, to wash, or to clean with. Additionally, the closed beverage bag 22 is ideally for environments without gravity liquids cannot be in open containers for human consumption. The beverage bag 29 is ideal for condensed space wherein the flexible material can form to the environment shape requirements more easily than any of the existing beverage containers currently out in the market. Additionally, the beverage bag 29 collapses as the consumption products 17 are consumed. The beverage bags 22 layers are ideal for condensed space storage, before using a consumption product 17 and for waste storage after a consumption product 17 is consumed. Furthermore, the material layers in this beverage bag 29 can be more easily separated for recycling. The beverage bag 22 has size versatility, shape versatility, utilization versatility, and activation versatility. The significantly less raw material in the beverage bags 22 will require significantly less energy for recycling.

Referring to FIG. 11, according to the preferred embodiment of the invention, a tokenization of various beverage bags 22 of different sizes, shapes and compositions is illustrated. Various open or close beverage bags 22 in conjunction with the NFT (Non-Fungible Token) and NIL (Name, Image and Likeness) technology creates a different industry to help reduce waste production, reduce raw material over-utilization and reduce consumer ideations in relation to disposable single beverage containers as trash. Through NFT and NIL's items the beverage container industry and consumers behavior modification can embrace new ideas to reduce the current ideation of beverage containers as waste products. The blockchain technology will provide the technology, currency, economy, trust, value, for the culture and community growth to embrace beverage bags 22 as souvenir, mementos, memorabilia and NFT play of the game. We have the technology to develop beverage bags 22 with less raw material, with one-of-a-kind creativity, with meaningful emotions visual, while providing an essential function of quenching our thirst and at the same time reduce waste through a creative platform for imagination and financial growth. It is important to mention the physical flexibility of the beverage bag 22 allows for convenience to fold or

collapse the beverage bag 22 for safekeeping to avoid the beverage bag 22 from becoming trash/waste. Additionally, the beverage bag 22 requires minimal space for long term storage. More important is the emotional sentiment the beverage bag 22 is able to provide to the owner. For example, the beverage bag 22 is purchased, gifted, or shared to enjoy a consumption product 17 during a special event. The beverage bag 22 is ideal and convenient for storing the design, graphic, logo on the beverage bag 22 to commemorate the event. And not just the event, the memories, the laughter, the reason why you when to the event and all the other circumstances that created the ideal moment in time, collapsible convenient and does not end-up in the waste deposit.

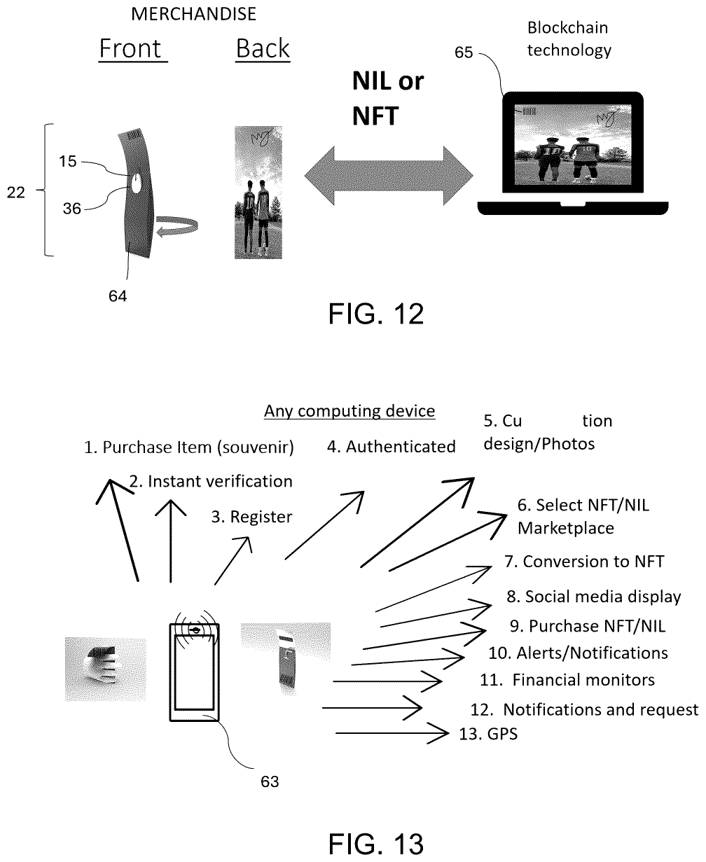

Referring to FIG. 12, according to the preferred embodiment of the invention, the tokenization of various beverage bags 22 of different sizes, shapes and compositions is illustrated. Various open or close beverage bags 22 with identification marker 65 used in conjunction with the NFT and NIL technology to create a novel industry to help reduce waste production, reduce raw material over-utilization and reduce consumer ideations in relation to disposable single beverage containers as trash. It is possible for the beverage bag 22 to be autograph 64 by an individual thereby increasing the sentimental value and the financial prospects. It is important to mention that the identification marker 65 is the process by which the current owner activates the NFT and or NIL certification/registration on a computing device 63 or any other digital device. In other words, the owner registers the beverage bag 22 with the identification marker 65. identification marker 65 can be anywhere throughout the beverage bag 22 and can be of any physical type numeric, square code, barcode, laser mark, traditional print mark, watermark, luminescent mark, chemical reactive mark, chip or tag, or conceal like the California lottery scratchers etc.

Referring to FIG. 13, according to the preferred embodiment of the invention, the computerization for activating the blockchain process of various beverage bags 22 of different sizes, shapes and compositions is illustrated. Various open or close beverage bags 22 with identification marker 65 used in conjunction with computer application on any computing device. The NFT and NIL technology will help create a novel industry to help reduce waste production, reduce raw material, reduce over-utilization and reduce consumer ideations in relation to disposable single beverage containers as trash. Through the smartphone computer application, the user takes pictures during the event and of the signature 64, then through the computer program the pictures and signature 64 can be pasted and position on the digital NFT or NIL. The NFT and or NIL designs will be pre-designated similar or not similar to the physical graphical designs on the physical beverage bag 22. Additionally, the smart phone computer program system will enable the user to customize the said design with any additional words, letters, numbers, pictures, symbols, emojis, avatars, or preexisting filter picture applications. The smartphone applications (APP) are capable of pre-purchasing the beverage bag, directions to the location for pick-up. Additionally, the smart phone location can be used to deliver the beverage bag 22. Through the smartphone application, the beverage bag identification marking can be verified for an instant price, register, and authenticated. The customization will be generated and displayed to the user, and, in the smartphone APP, the selected NFT marketplace providers will provide various options to the user and the prices to produce the NFT or NIL mementos, or customization. It is important to mention the owner of the beverage bag 22 (souvenir) has the choice to produce an NFT/NIL memento product at any time. The invention teaches a random selection process of any kind like the lottery or any raffle type of event in a random process to created and selected the NFTs at no financial cost to the winner, thereby elevating any souvenir, or NFT/NIL memento onto memorabilia statues. Thereby, any beverage bag 22 has the potential of becoming memorabilia, at no cost to the owner. Furthermore, any winning beverage bag 22 with the corrected identification marking will be offered an instant purchase of no less than 100 USD. At which point the physical beverage bag 22 must be returned, in order to collect the purchase price and the new buyer may keep the beverage bag and the digital NFT associated with the identification marker 65. In any case when the beverage bag 22 is randomly selected as a winner and is kept or sold, converting the original physical design in the beverage bag 22 to a digital blockchain design may or may not only be done for the original designs in the physical beverage bag 22, also any additional customization requested by the current owner at the time of registration may or may not be charged to the current owner, for that one winning event. It is important to mention the owner of any beverage bag 22 can create an NFT at their own cost through the computer program. The smartphone application will provide one or more NFT marketplace providers for helping illustrated the design with the topographical creation for the NFT or NIL and also provide the cost for creating the NTF or NIL. Both the customization and the cost for the creation of the said NFT and NIL can be provided in realtime or in a timely manner through the computer program.

Furthermore, register owners must be contemplated with not altering a NFT or NIL, it is posable that a digital NFT or NIL in mint condition without any changes to the blockchain are more valuable. According to the invention, the desirability for a beverage bag 22 with customization and without customization in either approach the goal is to reduce the beverage bag 22 from becoming waste product. With customization or without customization once the beverage bag 22 is created into an NFT or NIL then the smart contract digital work can be displayed in social media and furthermore all the NFTs and NILs are displayed to further grow within the community and culture. Being part of a community and participating in the culture psychologically motives the sales, the transfers, purchases, and the ownership of the beverage bag 22, and thereby also reduces the beverage bags 22 from becoming waste products 8. Furthermore, financial monitoring, notifications and requests can be done through a computer program. The invention is not limited to smartphones, computer programs can operate from any digital computing device like laptop, tablets, Virtual Reality, Mix Reality, Extended Reality, Augmented Reality, or hologram.

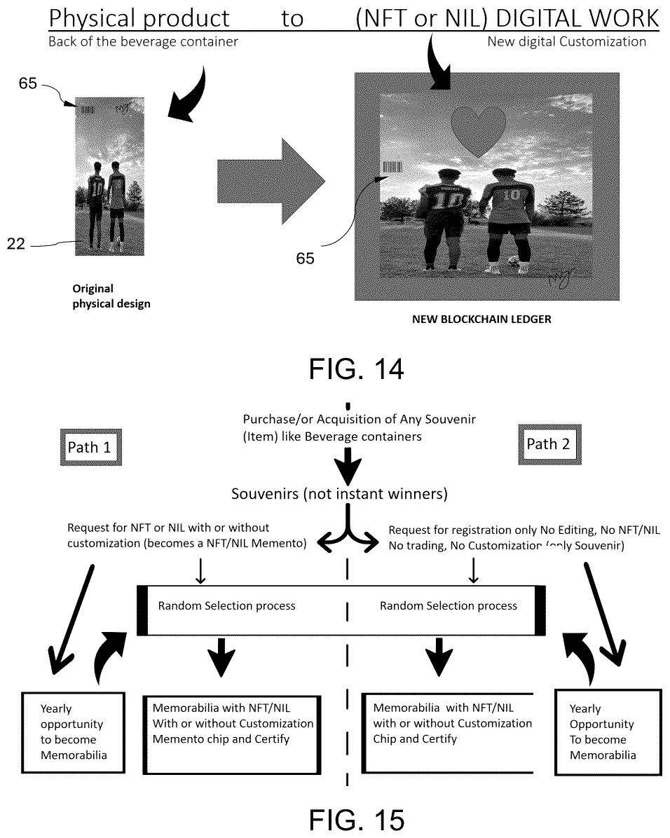

Referring to FIG. 14, according to the preferred embodiment of the invention, various beverage bags 22 of different sizes, shapes and compositions are illustrated. Consider the beverage bag 22 one of a kind because through the bag walls 29 any major event can be a different design, or different displays, in every individual event, the NFT and NIL markets will have a symbiotic relation with all future events. Through the association of the NFT and NIL, with the physical item (souvenir) the beverage bag 22 the physical designs, and the digital design are one. Therefore, the one-of-a-kinds beverage bag 22 commemorates the one-of-a-kind event and the NFT and NIL technology allows to customize the digital design associated with the physical event, through NFT or NIL items. The original beverage container designed may be customizable by the owner for creativity, emotional value or financial value. It is also possible for the original design on the physical beverage bag 22 not to be customized in the creation of the NFT or NIL. Additionally, the new owners may partially or completely delete past customizations done by past owners.

Referring to FIG. 15, according to the preferred embodiment of the invention, two pathways for any beverage bag 22 with or without NFT and NIL items (souvenir) are illustrated to become a computer digit work in the blockchain process as memorabilia from different events, functions, and occasions. Furthermore, the schematic teaches both pathways have a yearly opportunity for the beverage bag 22 identification marker 65 to be randomly selected as a winner elevating the beverage bag 22 status from souvenir to memorabilia status. It is important to mention the beverage bag 22 may be purchased or gifted and the beverage bag 22 may have or get one or more signatures becoming an NIL. In the first path the owner of the beverage bag may register the beverage bag 22 and eventually creates a NFT/NIL memento for himself. Once the NFT/NIL memento is created, the final design can be seen by others in the computer application, where others can comment, and may want to purchase. It is possible that, eventually, NFT/NIL memento gets selected as a winner, from the randomized process for creating memorabilia from the original purchase of the beverage bag 22. The invention discloses instant memorabilia random selection process as lottery scratchers or peeling a superimposed barrier design for blocking the visualization of the identification marker 65 form being identify by any computing device 63, until after registration. The beverage bag 22 with the selected identification marker 65 is certified and chip as memorabilia. In the second path, again the beverage bag 22 is purchased or gifted with or without NIL items. The owner or owners elect to keep possession of the beverage bag 22 without creating a NFT/NIL digital product that may have customization. It is possible that, eventually, the beverage bag 22 (souvenir) gets selected as a winner, from the randomized process created to produce memorabilia from the original purchase of the beverage bag 22. The beverage bag 22 with the selected identification marker 65 is certified and chip as memorabilia. The tokenization markets will have variabilities in the market because not all memorabilia in theory have a similar value. The price will different greatly by the number of NFT/NIL products created and the demand for a specific beverage bag 22 or event, the availability for purchase from the events, and whether or not the NFT is in mint condition without any customization, and when did the NFT become memorabilia, what are the current customizations if any. Through the computer application visitors will have all of these questions, answers and more. It is important to mention for each event it is possible to have a buy back option where the original buyer returns the beverage bag 22 and they are refunded a portion of the original purchase or given a stipend/coupon. This will further decrease the waste 8 production because the beverage bags 22 can be conveniently folded and returned, at the end of the event. Additionally, the merchant providing the beverage bags 22 may keep or destroy the discarded beverage bags 22 this will increase the exclusivity of the circulating beverage 22 as souvenirs or as NFT memento for that particular event. Ideally, every year there is a random drawing or raffle drawing for selecting memorabilia, any type of random selection. It is important to mention that the random drawing is not limited to one winner per event, it is possible to have multiple random drawings where the computer application will notify all the register owners. The goal is for the statistical odds in the random drawing to have a community threshold so that participating members continue in the culture of keeping their beverage bags 22.

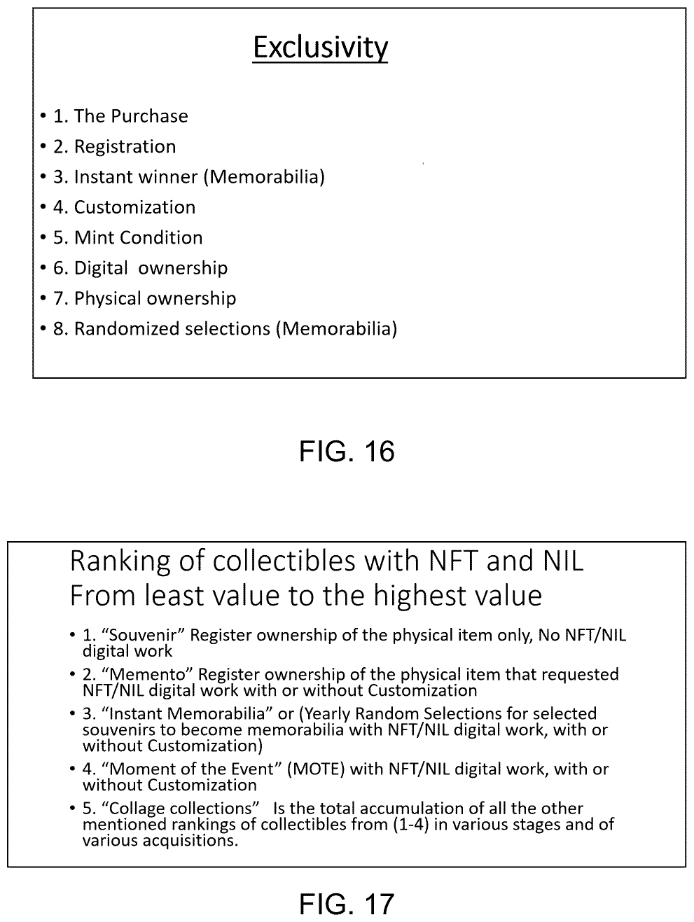

Referring to FIG. 16, according to the preferred embodiment of the invention, multiple exclusivities are illustrated that affect the financial growth for this market. Additionally, through the method and system the beverage bag 22 must be provided in the most desirable events, functions, and occasions, as a form of exclusivity. The development of the beverage bag 22 along with the NFT and NIL technological developments are among the functions that will reduce waste. Exclusivity is the way to create financial growth within the process of reducing waste products. The first exclusivity is the purchase of the beverage bag 22, by having the time and money to attend the event, therefore the purchase was posable. The second exclusivity is the registration, often couples and family share the same beverage. Who will be the owner? It is possible to have more than one registered owner, but who will make the decisions, this is the second form of exclusivity. The third form of exclusivity is instant winners, the invention teaches the play of the game NFT and the instant scratcher winners on the beverage bag 22, these two scenarios do not have a yearly random drawing because both scenarios are winners already. The play of the game NFT is the costliest and may be provided to the buyer's days to weeks after the event. The Play of the game NFT may or may not be the same as the other beverage bag 22. The Play of the game can be raffled or sold in an auction format before or after the game, or through the internet. The cost to create the NFT play of the game is included with or without blockchain customization. Through the identification marker 65, the blockchain digital work is identified with the one-of-a-kind design that may or may not be different from the event designs on the physical beverage bag 22. For example, in the instant scratcher winner the NFT creation design is similar to the design on the beverage bag 22 without customization. The fourth form of exclusivity is customization it will be limited to individuals that can afford to pay the cost of the NFT or NIL production. The customizable creation within the NFT or NIL can be of anything that is not offensive or hurtful, in any way. The fifth form of exclusivities is keeping the beverage bag 22 and the NFT or NIL digital creation in mint condition. In other words, the beverage bag 22 is not environmentally or physically damaged and the NFT and the NIL have no customization. All current and future owners will strangle with the question of customization. It is posable that customized NFT and NILs will lose value. The sixth form of exclusivity is physical ownership, it is posable for a couple to have shared ownership, where one person owns the physical beverage bag 22 and or NIL signature and the other person owns the physical contractual creation of the NFT or NIL (digital ownership) associated with that event and the beverage bag 22. The seventh form of exclusivity is the physical possession of the beverage bag 22. At the time the beverage bag 22 is randomly selected for memorabilia status. Years later, who physically continues to have position of the beverage bag. That beverage bag 22 must be returned for authentication to elevate that souvenir into memorabilia status. The eight exclusions are who is the owner of the physical and digital NFT or NIL. In other words, who is the person or group that has the ownership of the beverage bag 22, the NFT and the NIL. But also, WHO is the owner? Is the owner the president of the United States of America. Because that is a big exclusion. In other words, the price for that physical beverage bag 22 and the NFT or NIL will be significantly higher. These 8 exclusions formulated the bases from which financial growth can be monetized through the exchange of buying and selling new and old beverage bags 22 and the blockchain technology.

Referring to FIG. 17, according to the preferred embodiment of the invention, a ranking system for collectible NFTs and NILs based on the exclusions mentioned earlier in the invention is illustrated. It is important to mention that they are exceptions to the order of the ranking system as they rely on what the market is willing to purchase and sale. For example, the first in the rankings system should be the play of the game NFT with or without customization, these items should always be the most initially costly, because there is only one per event. The Play of the game NFT may not always be the costliest, it is possible for collage collections which have the second ranking to be among the costliest products. It all depends on whether the collage collection was owned by a famous person. Additionally, a collage collection may have multiple Play of the game NFT along with other NFT/NIL memorabilia, NFT/NIL mementos or souvenirs. The third type, typically any memorabilia with or without customization will be more expensive than souvenirs. It is important to mention memorabilia is produced at no cost to the current owner, from the random selection process between all souvenirs and NFT mementos with or without NIL. Furthermore, instant scratchers are memorabilia because the winner also participated in the random process to become an instant winner, through the original purchase. The fourth in the ranking system are NFT/NIL mementos, they are physical items that have blockchain activation with or without customization. They have not been selected through the random process for memorabilia, so their values are less than memorabilia. For example, the owner of a beverage bag 22 or NIL item may create an NFT with or without customization. In other words, this process can be costly to personalize the event, or occasion, as a NFT memento or NIL memento that is not yet a winner for memorabilia status. The fifth in the ranking system is souvenir that is any Beverage bag 22 with or without NIL signatures that have no digital computer work creation of any kind. In this ranking it is the least complex and most effortless. Through the computer application users may elect to display or not display the beverage bag 22 blockchain design they have registered. It is possible that a singular event out performance market expectations. Wherein, the people that purchase the beverage bag 22 at the event can sell them at a profit, instantly. It is important to mention that, even if the beverage bag 22 (souvenir) was registered to someone else, the new owner will be able to re-register the beverage bag through the identification marker 65 and the computer program. The new owner has all the rights of the original owner in relation to memorabilia selection and customization.

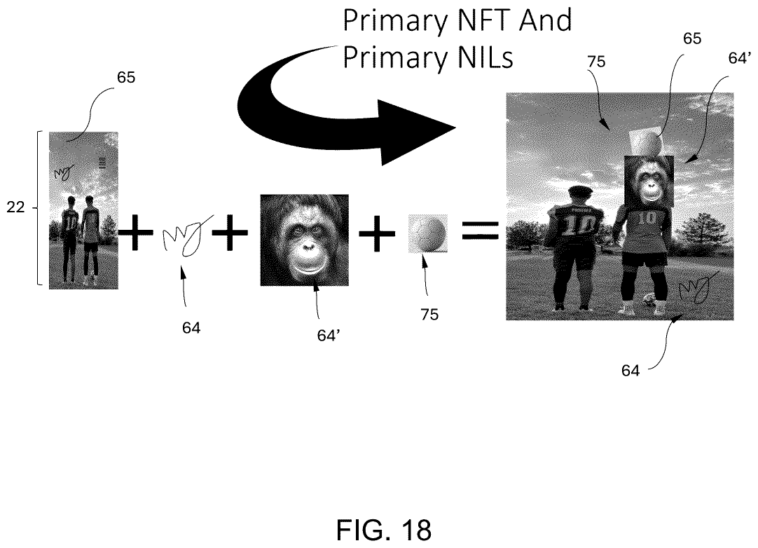

Referring to FIG. 18, according to the preferred embodiment of the invention, a collection of other NFTs and NILs along with the beverage bag 22 NFT or NIL is illustrated. It is important to mention everything mentioned in this embodiment for the NFT memento or NFT memorabilia also applies to the NIL memento or NIL memorabilia. This invention provides the method and system for any physical item in synergy with NFT and NIL working together to procure monetary value while providing a function, a personal connection or an emotionally circumstantial attachment, thereby incentivizes a desire behavior. Additionally, NIL products like signatures “autographs products”, social media clips, other custom apparels including other digital products like NFT, and crypto products can be incorporating, edited, or attached to the NTF or NIL in this invention, therefore, “The Primary NFT or the Primary NIL” have exclusive usage. In other words, the invention teaches the value of the primary NFT and the exclusive use within the primary NFT in relation to other NFT products to increase and maintain the monetary value of the primary NFT in the invention. The primary NFT requires exclusivity by the customer, and by the NFT community to execute intellectual property standers superimposed on other physical products like custom apparels and digital products like other NFTs, and NILs or crypto products operating now or in the future. In other words, the invention can have other NFTs with or without customization, wherein the other NFT products may or may not be associated or have any portion of said “The Primary NFT”, or components of this invention. Additionally, other NFTs products may or may not have a physical association with other items like mentioned in the invention. The primary NFT may or may not have an association with the other digital product in relation to the primary NFT. The same concept applies to the primary NIL for example the signature of an item that can be made into an NFT. For example, FIG. 18 on the right side illustrates the final blockchain created by the owner (customization), wherein the identification mark 65 has been relocated in comparison to the original blockchain that is similar to the original physical design in the beverage bag 22 (souvenir), the signature 64 from the winning goal ball 75 has also been copy, by the owner of a valuable NFT digital work 64′ (monkey). The final blockchain Primary NFT on the right side illustrates the final design, wherein a valuable NFT digital work 64′ of a monkey that is covering the head of his friend nickname “monkey” and plays with the opposite team and the ball 75 is positioned on the valuable NFT digital work 64′, because during the game that fan was accidentally hit on the head, it is the ball 75 that eventually became the game winning ball 75 and now has the signature of his favorite soccer player that made winning goal. For example, Bore Ape Yath Club NFT attempts to mimic human personality. The invention intergrades reality (physical items) with digital work through smart contracts. This is one example of many illustrating the complexity of the invention in relation to customization and Primary NFT or Primary NIL. This customization can be a lot simpler or can be incredibly complex. Take way all the alterations and you are left with the original digital work the Primary NFT or the Primary NIL. Customization can be never ending, and can be authenticated, any customization done by an individual will be memorialized forever through the blockchain technology.

One skilled in the art will understand that the embodiment of the present invention as shown in the drawings and described above is exemplary only and not intended to be limiting.

It will thus be seen that the objectives of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A beverage container, comprising:
a portable flexible beverage bag comprising a bag wall configured by an inner layer and an outer layer to have at least one display surface, an absorbent layer surrounded by the outer layer and by the inner layer;
a valve positioned in a predetermined location of the beverage bag enabling an orifice for the absorbent material;
a dispensing apparatus arranged in the bag wall; and
an identification marker which is a tokenization conjunction with NFT or NIL technology formed on the at least one display surface of the bag wall of the beverage bag.

2. The beverage container, as recited in claim 1, wherein the bag wall is made of a material selected from a group consisting of plastic, paper, glass, aluminum, and a combination of one or more of the plastic, paper, glass, and aluminum.

3. The beverage container, as recited in claim 2, wherein the absorbent layer is made of a material selected from a group consisting of a layer medium of wood fiber, sponge like material, cotton fiber, gelatin crystal, and powder reactive to a solvent to produce a reaction.

4. The beverage container, as recited in claim 1, wherein the identification marker is provided to allow a user of the beverage container to be registered through a digital computing device to activate a NFT or NIL blockchain ledger.

5. The beverage container, as recited in claim 4, wherein the identification marker is selected from a group consisting of any physical numeric mark, lettering, symbols, a square code, a barcode, a laser mark, a print, a watermark, a luminescent mark, a chemical reactive mark, a chip, a tag, conceal scratcher, UPC, EAN, JAN, ISBN, Brand, and any MPN.

6. The beverage container, as recited in claim 2, wherein the identification marker is provided to allow an user of the beverage container to be registered through a digital computing device to activate a NFT or NIL blockchain digital application options.

7. The beverage container, as recited in claim 6, wherein the identification marker is selected from a group consisting of a physical numeric mark, lettering, symbols, a square code, a barcode, a laser mark, a print, a watermark, a luminescent mark, a chemical reactive mark, a chip, a tag, conceal scratcher, UPC, EAN, JAN, ISBN, Brand, and any MPN.

8. The beverage container, as recited in claim 3, wherein the identification marker is provided to allow an user of the beverage container to be registered through a digital computing device to activate a NFT or NIL blockchain server.

9. The beverage container, as recited in claim 8, wherein the identification marker is selected from a group consisting of a physical numeric mark, a square code, a barcode, a laser mark, a print, a watermark, a luminescent mark, a chemical reactive mark, a chip, a tag, and a conceal scratcher.

10. The blockchain technology, as recited in claim 1, wherein the identification marker is selected from a group consisting of a physical numeric mark, lettering, symbols, a square code, a barcode, a laser mark, a print, a watermark, a luminescent mark, a chemical reactive mark, a chip, a tag, conceal scratcher, UPC, EAN, JAN, ISBN, Brand, and any MPN, in association with a physical item.

11. The blockchain technology, as recited in claim 10, wherein the identification marker is selected from a group consisting of a physical numeric mark, a square code, a barcode, a laser mark, a print, a watermark, a luminescent mark, a chemical reactive mark, a chip, a tag, conceal scratcher, UPC, EAN, JAN, ISBN, Brand, and any MPN, that never changes regardless of any blockchain customization or alteration.

12. A beverage container, comprising:
a portable flexible beverage bag comprising a bag wall configured by an inner layer and an inner layer to have at least one display surface, an absorbent layer surrounded by the outer layer, wherein an inner space is defined between the inner layer and the outer layer sealedly;
a valve positioned in a predetermined location of the beverage bag communicating the inner space with outside; and
a dispensing apparatus arranged in the bag wall.

13. The beverage container, as recited in claim 12, wherein a sealing between the inner layer and the outer layer is in an air-seal and airtight manner and the valve is configured to provide an orifice between the inner layer and the outer layer for activating the absorbent layer with a chemical reaction externally and enable an extraction of air pressure in the inner space.

14. The beverage container, as recited in claim 13, wherein the absorbent layer is a layer made of a medium selected from a group consisting of wood fibers, sponge like material, cotton fibers, gelatin crystals and a powder reactive to a solvent to produce the chemical reaction.

15. The beverage container, as recited in claim 13, further comprising a valve connector configured to introduce an activator selected from a group consisting of water, solvents, solutes, air pressure, vacuum pressure into the inner space affecting the absorbent layer.

16. The beverage container, as recited in claim 14, further comprising a valve connector configured to introduce an activator selected from a group consisting of water, solvents, solutes, air pressure, vacuum pressure into the inner space affecting the absorbent layer.

17. The beverage container, as recited in claim 12, wherein the absorbent layer is activated by being compressed, wherein a compression of the absorbent layer by reducing an air pressure of the inner space provides rigidity to the outer layer and the inner layer such that a cooling agent is able to be introduced to the absorbent layer through the valve, wherein the cooling agent reduces a temperature in the inner space.

18. The beverage container, as recited in claim 16, wherein the absorbent layer is activated by being compressed, wherein a compression of the absorbent layer by reducing an air pressure of the inner space provides rigidity to the outer layer and the inner layer such that a cooling agent is able to be introduced to the absorbent layer through the valve, wherein the cooling agent reduces a temperature in the inner space.

19. The beverage container, as recited in claim 12, wherein the valve connector is configured to introduce one of a liquid and a solvent into the inner space to activate the absorbent layer.

20. The beverage container, as recited in claim 12, further comprising a water provided in beverage bag and mixed with a material of the absorbent layer and inner surfaces of the inner layer and the outer layer, wherein the material of the absorbent layer is selected from a group consisting of cotton fibers, synthetic fibers, natural fibers, and man-made fibers like synthetic material, wherein an air space reaction in relation to the inner layer, the outer layer and the absorbent layer and the chemical reaction within the absorbent layer causing a change in physical state of the absorbent layer within the inner space so as to reduce an air pressure of in the inner space.
